(19) United States
(12) Patent Application Publication
(10) Pub. No.: US 2010/0008509 A1
(43) Pub. Date: Jan. 14, 2010

(54) COMMUNICATION APPARATUS, KEY SERVER, AND MANAGEMENT SERVER

(75) Inventors: Tatsuyuki Matsushita, Tokyo (JP); Ryuiti Koike, Tokyo (JP); Hideki Matsumoto, Kanagawa (JP); Kentaro Umesawa, Kanagawa (JP); Taku Kato, Kanagawa (JP); Haruhiko Toyama, Kanagawa (JP); Hideaki Sato, Kanagawa (JP); Toru Kambayashi, Kanagawa (JP); Satoshi Ito, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/368,674

(22) Filed: Feb. 10, 2009

(30) Foreign Application Priority Data
Jul. 11, 2008 (JP) 2008-181885

(51) Int. Cl. H04L 9/14

(52) U.S. Cl. 380/279

(57) ABSTRACT

A communication apparatus obtains file information indicating all or a part of first and second encrypted pieces obtained by encrypting a plurality of pieces constituting a part of a content and version management information with which it is possible to judge whether the file information has validity and receives, for each of the pieces, one of the first encrypted piece and the second encrypted piece from another communication apparatus, by using the file information. The communication apparatus transmits, to a key server, a request message for requesting decryption keys each being used for decrypting the one of the first encrypted piece and the second encrypted piece received for a different one of the pieces and the version management information of the file information used to obtain the one of the first encrypted piece and the second encrypted piece in correspondence with each of the pieces and receives the decryption keys.

### CROSS-REFERENCE TO RELATED APPLICATIONS

This application is based upon and claims the benefit of priority from the prior Japanese Patent Application No. 2008-181885, filed on Jul. 11, 2008; the entire contents of which are incorporated herein by reference.

### BACKGROUND OF THE INVENTION

1. Field of the Invention

The present invention relates to a communication apparatus that receives an encrypted content encrypted with an encryption key from another communication apparatus, a key server that transmits a decryption key used for decrypting the encrypted content, and a communication apparatus, a key server, and a management server that each store therein information used by a communication apparatus to access another communication apparatus.

2. Description of the Related Art

Generally speaking, systems used for distributing contents include “single server” systems and “distributed server” systems. In a single-server system, for example, one content server is connected to a license server and clients via a network so that a content is distributed from the content server to each of the clients. The distributed content is encrypted, and key information related to the encryption process is stored in the license server. The content server stores the content therein as E(KT) [C]. In this expression, “KT” is a key called a title key, whereas “C” is a content in plain text. E(KT) [C] means that “C” is encrypted with “KT”. The key information contains “KT”. A client B obtains the key information from the license server, encrypts the key information with a key KB that is unique to the client (i.e., the client B), and stores therein the encrypted key information in correspondence with the content E(KT) [C] that has been received from the content server. After that, the client B decrypts the key information with the key KB, takes out the title key KT, and decrypts the content E(KT) [C] with the title key KT. Thus, the client B is able to use the content.

In this configuration, when the client B downloads the content E(KT) [C] from the content server, the client B and the content server perform an authentication process and a key exchange process with each other. As a result, the client B shares a temporary key KtmpB. The content server encrypts the content E(KT) [C] with the temporary key KtmpB and transmits a content E(KtmpB) [E(KT) [C]] to the client B. The client B decrypts the content E(KtmpB) [E(KT) [C]] with the temporary key KtmpB that the client B shares with the content server as a result of the authentication and the key exchange processes described above and takes out E(KT) [C]. In this configuration, even if the encrypted content E(KtmpB) [E(KT) [C]] is illegitimately read on a path in the network, it is not possible to decrypt the illegitimately read content unless the temporary key KtmpB is available. In other words, the content is encrypted with the temporary key that is different for each of the clients, so that the content is individualized for each of the clients. As a result, it is possible to inhibit illegitimate use of the content. For example, by configuring a temporary key KtmpA for a client A and the temporary key KtmpB for the client B so as to be different from each other, a content E(KtmpA) [E(KT) [C]] distributed to the client A and the content E(KtmpB) [E(KT) [C]] distributed to the client B are mutually different individual pieces of data. By individualizing the content with the mutually different encryption keys in this manner, it is possible to inhibit illegitimate use of the content.

In a single-server system, however, because the communication is performed between each of the clients and the content server in a one-to-one manner, when a large number of clients try to receive the distribution of a content from the content server, a problem arises where the level of distribution efficiency is lowered.

On the other hand, examples of the distributed-server systems include a content distribution system called BitTorrent that uses a peer-to-peer (P2P) network (see, for example, BitTorrent Protocol Specification v. 1.0). In this system, a tracker that is different for each of the contents, a seeder, and a leecher are connect to one another by using the P2P network. Also, each of the distributed contents is divided into a plurality of pieces. The seeder is a node that distributes the pieces constituting a content for the purpose of distributing (i.e., uploading) the content. The leecher is a node that receives the pieces constituting the content and distributes the pieces constituting the content for the purpose of receiving (i.e., downloading) the content. In other words, a leecher may become a seeder when the leecher has obtained a certain number of pieces that constitute the content. Thus, some of the seeders have become a seeder after a leecher has received a part or all of the pieces that constitute a content, and other seeders are each a seeder (from the beginning) that is provided on the system side (in advance or during a distribution). The latter type of seeders will be referred to as initial seeders. An initial seeder stores therein a part or all of the pieces that constitute one content. In the explanation below, a “seeder” denotes either a seeder or an initial seeder, unless stated otherwise. A node denotes one of a leecher, a seeder, and an initial seeder. A tracker stores therein node information related to each of the nodes. When a leecher has accessed the tracker, the tracker provides the node information for the leecher.

In this configuration, when a leecher is to receive a distribution of a content, the leecher first obtains information called a Torrent File. The Torrent File is, for example, given from a server (hereinafter, a “sales server”) offering a service of selling contents to content providers or users, to another node or another sales server, and is further given by the another node or the another sales server to a leecher. Alternatively, another arrangement is acceptable in which the Torrent File is recorded on a recording medium like a Compact Disk Read-Only Memory (CD-ROM) and distributed offline to a leecher. The Torrent File stores therein tracker information related to the content and file information of the content. The tracker information contains a connection destination of the tracker. The file information contains, for example, hash information of the pieces that constitute the content. The hash information is used for checking the completeness of the pieces. In other words, the hash information is used for calculating hash values of the pieces downloaded by the leecher, comparing the calculated hash values with hash values of the pieces, and checking to see if the received pieces have not been tampered.

When having obtained the Torrent File, the leecher connects to the tracker based on the tracker information. The tracker transmits the node information described above to the leecher. The node information contains a list of connection destinations of one or more nodes. The leecher connects to a plurality of nodes, based on the node information. As for the pieces distributed by the nodes, it is often the case that the pieces are mutually different for each of the nodes. Because the leecher is able to receive the mutually different pieces from the plurality of nodes, the leecher is able to receive the content at a high speed.

As explained above, in such a content distribution system that uses a P2P network, the content is stored as being distributed in the plurality of nodes. Thus, in such a system, even if a large number of nodes try to receive the distribution of the content, each of the node is able to receive the distribution of the content from the plurality of other nodes via the P2P network. Thus, P2P content distribution systems have a higher level of distribution efficiency than single-server systems.

In a content distribution system as described above where it is possible to distribute a content through a plurality of nodes, it is also desirable to protect the distributed content with an encryption process so that it is possible to inhibit illegitimate use of the content. In such a content distribution system, however, a content that is received by mutually different leechers from a seeder must be the same for all the leechers even after the content has been encrypted, unlike in a single-server system. Thus, it is difficult to distribute an individually encrypted content to each of the leechers. Consequently, if one key that is used for decrypting the encrypted content is disclosed, there is a possibility that it may become possible to decrypt all of the large number contents that are present in the network.

Patent Publication No. 3917395 discloses a content distributing method by which a content is divided into a plurality of pieces, and each of the pieces that is in plain data is encrypted with a plurality of encryption keys so that encrypted data (hereinafter, “encrypted pieces”) are generated.

The content distributing method disclosed in Patent Publication No. 3917395 requires that each of the users who are to receive the distribution of the content should obtain all the encrypted pieces. Thus, when this content distributing method is applied to a P2P content distribution system without any modification, there is a possibility that the level of distribution efficiency may be lowered. Further, even if there are a plurality of keys used for decrypting the encrypted content, if the keys are disclosed, there is a possibility that it may become possible to decrypt the content without having to legitimately obtain the decryption keys. In other words, there is a possibility that it may become possible to illegitimately use the content without paying a fee. With regard to illegitimate use of the content, two examples of illegitimate actions are as follows: One example is that a user illegitimately uses the content by using a plurality of decryption keys that have been disclosed by another user. In other words, the user downloads all the encrypted pieces that constitute the content and, when the plurality of decryption keys with which it is possible to decrypt the content have been leaked, the user obtains the decryption keys and decrypts the content by decrypting the downloaded encrypted pieces. The other example is that a user allows another user to illegitimately use the content. In other words, the user purchases all or a large part of the decryption keys used for decrypting all the encrypted pieces that constitute the content and discloses all the decryption keys by using a certain method, so that another user is able to decrypt the content. To cope with these situations, it is necessary to take measures in a content distribution system so as to reduce the damage that is caused when the decryption keys are disclosed by such illegitimate actions.

### SUMMARY OF THE INVENTION

According to one aspect of the present invention, a communication apparatus that receives a plurality of pieces that constitute a part of a content, wherein a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, and the communication apparatus includes an information obtaining unit that obtains file information indicating all or a part of the first and the second encrypted pieces and version management information capable of judging whether the file information has validity; a content receiving unit that receives, for each of the pieces, one of the first encrypted piece and the second encrypted piece from another communication apparatus by using the file information; a transmitting unit that transmits, to a key server, a request message for requesting decryption keys each of which is used for decrypting the one of the first encrypted piece and the second encrypted piece received by the content receiving unit for a different one of the pieces and the version management information of the file information used to obtain the one of the first encrypted piece and the second encrypted piece in correspondence with each of the pieces; and a key receiving unit that receives the decryption keys provided by the key server in response to the request message.

According to another aspect of the present invention, a communication apparatus that receives a plurality of pieces that constitute a part of a content, wherein a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, and the communication apparatus includes a content receiving unit that receives, for each of the pieces, one of the first encrypted piece and the second encrypted piece from another communication apparatus; a key request transmitting unit that transmits, to a key server storing decryption keys, a request message for requesting the decryption keys each of which is used for decrypting the one of the first encrypted piece and the second encrypted piece received by the content receiving unit for a different one of the pieces; a request receiving unit that receives, from the key server, an information request message for requesting storing proof information to prove that the communication apparatus stores the encrypted pieces that are to be decrypted by using the decryption keys requested in the request message and each of which is the one of the first encrypted piece and the second encrypted piece corresponding to a different one of the pieces; an information transmitting unit that transmits the storing proof information to the key server in response to the information request message; and a key receiving unit that receives all or a part of the decryption keys provided by the key server based on the storing proof information and the request message.

According to still another aspect of the present invention, a key server that communicates with a communication apparatus that receives a plurality of pieces that constitute a part of a content, wherein a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, the communication apparatus receives, for each of the pieces, one of the first encrypted piece and the second encrypted piece from another communication apparatus, and the key server includes a request receiving unit that receives, from the communication apparatus, a request message for requesting decryption keys each of which is used for decrypting the one of the first encrypted piece and the second encrypted piece corresponding to a different one of the pieces and version management information capable of judging whether file information has validity, the file information having been used to obtain the one of the first encrypted piece and the second encrypted piece in correspondence with each of the pieces; a first storage unit that stores the decryption keys; a second storage unit that stores validity information used for identifying the version management information of one or more pieces of file information having validity; a judging unit that judges whether the decryption keys requested in the request message are valid by using the received version management information and the validity information; a determining unit that determines whether the decryption keys should be transmitted, based on a combination of the decryption keys requested in the request message, when the judging unit has judged that the decryption keys are valid; and a key transmitting unit that reads the decryption keys corresponding to the combination requested in the request message from the first storage unit and transmits the read decryption keys to the communication apparatus, when the determining unit has determined that the decryption keys should be transmitted.

According to still another aspect of the present invention, a key server that communicates with a communication apparatus that receives a plurality of pieces that constitute a part of a content, wherein a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, the communication apparatus receives, for each of the pieces, one of the first encrypted piece and the second encrypted piece from another communication apparatus, and the key server includes a request receiving unit that receives, from the communication apparatus, a request message for requesting decryption keys each of which is used for decrypting the one of the first encrypted piece and the second encrypted piece corresponding to a different one of the pieces; a first storage unit that stores the decryption keys; a second storage unit that stores storing judgment information used for judging whether the communication apparatus stores encrypted pieces that are to be decrypted by using the decryption keys requested in the request message and each of which is the one of the first encrypted piece and the second encrypted pieces corresponding to a different one of the pieces; a request transmitting unit that transmits, to the communication apparatus, an information request message for requesting storing proof information to prove that the communication apparatus stores the encrypted pieces that are to be decrypted by using the decryption keys requested in the request message and each of which is the one of the first encrypted piece and the second encrypted pieces corresponding to a different one of the pieces; an information receiving unit that receives the storing proof information from the communication apparatus; a storing proof judging unit that judges whether the communication apparatus stores the encrypted pieces that are to be decrypted by using the decryption keys requested in the request message and each of which is the one of the first encrypted piece and the second encrypted piece corresponding to a different one of the pieces, by using the received storing proof information and the stored storing judgment information; a determining unit that determines whether the decryption keys should be transmitted, based on a combination of the decryption keys requested in the request message, when the storing proof judging unit has judged that the communication apparatus stores the encrypted pieces; and a key transmitting unit that reads the decryption keys corresponding to the combination requested in the request message from the first storage unit and transmits the read decryption keys to the communication apparatus, when the determining unit has determined that the decryption keys should be transmitted.

According to still another aspect of the present invention, a management server that communicates with a communication apparatus that receives a plurality of pieces that constitute a part of a content, wherein a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, file information indicates all or a part of the first and the second encrypted pieces and is in correspondence with version management information with which it is possible to judge whether the file information has validity, the communication apparatus receives, for each of the pieces, one of the first encrypted piece and the second encrypted piece from another communication apparatus, by using the file information, and the management server includes a first storage unit that stores connection destination information used for accessing the another communication apparatus; and an information transmitting unit that transmits the connection destination information used for accessing the another communication apparatus, when the communication apparatus has accessed the management server by using first access information that is in correspondence with the file information and is used for accessing the management server.

### BRIEF DESCRIPTION OF THE DRAWINGS

FIG. 1 is a block diagram of a basic content distribution system according to an exemplary embodiment of the present invention;

FIG. 2 is a schematic drawing for explaining how a content is divided into a plurality of pieces;

FIG. 3 is a schematic diagram illustrating encrypted pieces;

FIG. 4 is a diagram illustrating an example of encrypted pieces stored in a seeder 52A;

FIG. 5 is a diagram illustrating another example of the encrypted pieces stored in the seeder 52A;

FIG. 6 is a diagram illustrating yet another example of the encrypted pieces stored in the seeder 52A;

FIG. 7 is a diagram illustrating an example of a data structure of piece information;

FIG. 8 is an exemplary basic functional diagram of a leecher 50;

FIG. 9 is a diagram illustrating an example of a basic Torrent File;

FIG. 10 is an exemplary basic functional diagram of a key server 53;

FIG. 11 is a diagram illustrating an example of a data structure of node information;

FIG. 12 is a flowchart of a basic procedure in a content distributing process;

FIG. 13 is a flowchart of a basic procedure in a comparing process;

FIG. 14 is a drawing illustrating an example of a data structure of a Torrent File according to the first embodiment;

FIG. 15 is an exemplary functional diagram of a key server 53 in a configuration example;

FIG. 16 is a flowchart of a procedure in a comparing process according to the first embodiment;

FIG. 17 is a drawing illustrating an example of a data structure of a Torrent File according to a modification example of the first embodiment;

FIG. 18 is a drawing illustrating an example of index information that contains hash values, according to a modification example of the first embodiment;

FIG. 19 is a drawing illustrating an example of a Torrent File according to a modification example of the first embodiment;

FIG. 20 is an exemplary functional diagram of the leecher 50 according to a modification example of the first embodiment;

FIG. 21 is a flowchart of a procedure in a content distributing process performed in a content distribution system according to a modification example of the first embodiment;

FIG. 22 is an exemplary functional diagram of the leecher 50 according to a second embodiment of the present invention;

FIG. 23 is an exemplary functional diagram of the key server 53 according to the second embodiment;

FIG. 24 is a flowchart of a procedure in a comparing process according to the second embodiment;

FIG. 25 is an exemplary diagram of a key server according to a modification example;

FIG. 26 is a flowchart of a procedure in a comparing process according to a modification example;

FIG. 27 is a drawing illustrating an example of piece information according to a modification example;

FIG. 28 is a drawing illustrating another example of piece information according to the same modification example;

FIG. 29 is a drawing illustrating yet another example of piece information according to the same modification example;

FIG. 30 is a flowchart of a procedure in a content distributing process performed in a content distribution system according to the same modification example;

FIG. 31 is a flowchart of a procedure in a content distributing process performed in a content distribution system according to a modification example;

FIG. 32 is an exemplary functional diagram of the leecher 50 according to a modification example;

FIG. 33 is a drawing illustrating an example of a data structure of a piece request according to the same modification example;

FIG. 34 is a flowchart of a procedure in a content distributing process performed in a content distribution system according to the same modification example; and

FIG. 35 is a flowchart of a detailed procedure in a downloading process and an uploading process according to the same modification example.

### DETAILED DESCRIPTION OF THE INVENTION

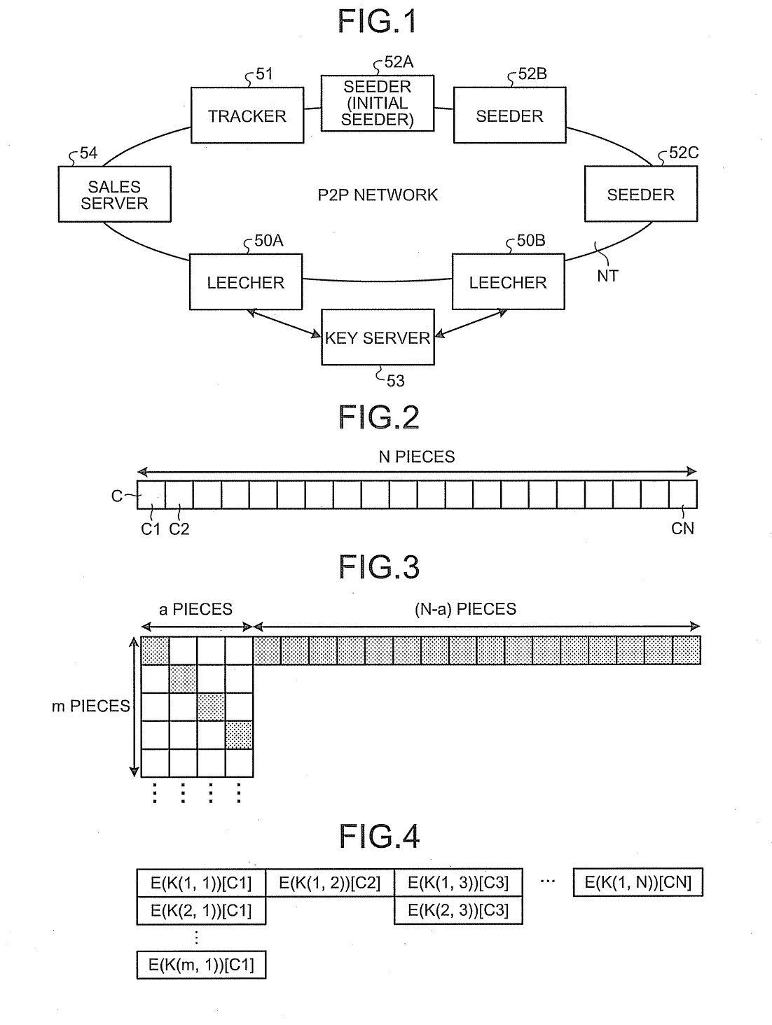

First, a basic configuration of a content distribution system according to a first embodiment of the present invention will be explained. FIG. 1 is a block diagram of a content distribution system according to an exemplary embodiment of the present invention. In the content distribution system according to the present embodiment, leechers 50A, 50B, a tracker 51, seeders 52A, 52B, 52C, and a sales server 54 are connected together via a P2P network NT. Each of the leechers 50A and 50B is connected to the key server 53 via a network like the Internet (not shown). In this situation, each of the leechers 50A and 50B and the seeders 52A, 52B, and 52C is a node. Each of the seeders 52A, 52B, and 52C stores therein encrypted pieces obtained by encrypting a plurality of pieces into which a content has been divided, with mutually different encryption keys. In the following explanation, a content that is constituted with such encrypted pieces will be referred to as an encrypted content. The details of such an encrypted content will be explained later. Of the seeders 52A, 52B, and 52C, the seeder 52A functions as an initial seeder, which is explained above. The seeder 52A stores therein all of the encrypted pieces that have been generated by encrypting each of the pieces constituting the one content by using a plurality of encryption keys per piece and a Torrent File. The tracker 51 stores therein node information used for accessing each of the nodes. It is assumed that a piece of node identification information is assigned to each of the nodes. Each piece of node identification information is information that uniquely identifies the node and may be, for example, an IP address of the node. The key server 53 stores therein decryption keys used for decrypting the encrypted pieces. The sales server 54 stores therein a Torrent File.

The leecher 50A receives the Torrent File from the sales server 54, obtains the node information by accessing the tracker 51 based on the Torrent File, receives the decrypted pieces by accessing at least one of the seeders 52A, 52B, 52C, and the leecher 50B based on the obtained node information, obtains all the encrypted pieces corresponding to the pieces, and receives a key-ring containing the decryption keys that are respectively used for decrypting the encrypted pieces from the key server 53. The leecher 50B also performs the same processes. In the following explanation, in the case where the leechers 50A and 50B do not need to be distinguished from each other, each of them will be simply referred to as the leecher 50. Similarly, in the case where the seeders 52A, 52B, and 52C do not need to be distinguished from one another, each of them will be simply referred to as a seeder 52.

Next, a configuration of the content will be explained. The content is any of various types of digital data such as moving-picture data and audio data like Moving Picture Experts Group (MPEG) 2 and MPEG 4 as well as text data and still image data. Also, data that is obtained by encrypting such digital data will be also referred to as a content. For example, data that is obtained by encrypting a High Definition Digital Versatile Disk (HD DVD) prepared video content according to the Advanced Access Content System (AACS) specifications can also serve as a content. In the following explanation, the entire content will be identified as “C”. The content “C” may be in plain text or encrypted. FIG. 2 is a schematic drawing for explaining how the content is divided into a plurality of pieces. For example, one content (i.e., the content C in the present example) is divided into as many pieces as N (N>1), the pieces being identified as C1 to CN. The data lengths of the pieces C1, C2, . . . , CN may all be equal or may be different from one another. The pieces C1 to CN, the quantity of which is equal to “N”, are encrypted with mutually different encryption keys. In this situation, of the N pieces, each of as many pieces as “a” is encrypted by using as many mutually different encryption keys (a first encrypted key and a second encrypted key) as “m” per piece. Each of the remaining pieces, the quantity of which is equal to “N−a”, is encrypted by using one encryption key (a first encrypted key) per piece. In other words, as for each of some of the pieces the quantity of which is equal to “a”, the piece is encrypted with the mutually different encryption keys the quantity of which is equal to “m”, so that the mutually different pieces (i.e., the encrypted pieces) the quantity of which is equal to “m” are generated. As for each of the other pieces the quantity of which is equal to “N−a”, the piece is encrypted with the one encryption key so that the one encrypted piece is generated for the one piece. FIG. 3 is a schematic diagram illustrating the encrypted pieces. It is possible to individualize the entire encrypted content that is constituted with as many encrypted pieces as “N”, by differentiating the combination of encrypted pieces that is obtained by selecting one out of as many encrypted pieces as “m” for each of the pieces the quantity of which is equal to “a”.

It is acceptable if the process of dividing the content into the pieces and the process of encrypting each of the pieces are performed by any of the tracker 51, the key server 53, and a server provided by the content creator. In the following explanation, an apparatus that performs at least one of these processes will be referred to as a piece processing apparatus. It is also assumed that the encrypted pieces are given to the seeder 52A (i.e., the initial seeder) by any of the tracker 51, the key server 53, and a reliable third party (e.g., a server provided by the content creator).

Next, a hardware configuration of each of the apparatuses such as the leecher 50, the tracker 51, the seeder 52, and the key server 53 will be explained. Each of the apparatuses includes: a controlling device such as a Central Processing Unit (CPU) that exercises the overall control of the apparatus; storage devices such as a Read-Only Memory (ROM) and a Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; and a bus that connects these constituent elements to one another. Each of the apparatuses has a hardware configuration to which a commonly-used computer can be applied. In addition, a display device that displays information, input devices such as a keyboard and a mouse that receive inputs of instructions from the user, and a communication interface (I/F) that controls communication with external apparatuses are connected to each of the apparatuses in a wired or wireless manner.

Next, various types of functions that are realized in the hardware configuration described above when the CPU of the seeder 52 executes the various types of programs stored in the storage devices and the external storage devices will be explained. The seeder 52 stores therein the encrypted pieces that have been obtained by encrypting the plurality of pieces C1 to CN constituting the content C, in correspondence with indexes (i.e., suffixes) of the decryption keys that are used for decrypting the pieces C1 to CN, respectively. The decryption keys may be the same as the encryption keys or may be different from the encryption keys. In either situation, because the pieces C1 to CN have been encrypted with the encryption keys respectively, it is possible to identify each of the encrypted pieces by using the index of the corresponding one of the decryption keys used for decrypting the encrypted piece. These encrypted pieces are stored in, for example, an external storage device.

To simplify the explanation in the following sections, it is assumed that the encryption keys are identical to the decryption keys, respectively. In the case where the index of each decryption key is expressed as (i,j), and the decryption key is expressed as K(i,j), each encrypted piece can be expressed as below, for example:
E(K(i,j)) [Cj]
where i and j are integers that satisfy 1=i=m and 1=j=N (m>1); With regard to mutually different indexes (i,j) and (i′,j′) where (i,j)≠(i′,j′), K(i,j)=K(i′,j′) may be satisfied.

The encrypted content that is constituted with the encrypted pieces can be expressed as below, for example:
{E(K(i1,1)) [C1], E(K(i2,2)) [C2], . . . , E(K(iN,N)) [CN]}
where 1=i1, . . . , iN=m is satisfied.

The sequence of the encrypted pieces in the encrypted content is expressed with the combination of the indexes of the encrypted pieces and can be expressed as below, for example (In the example below, the indexes corresponding to the pieces C1 to CN are arranged in a row from the left side):
{(i1,1), (i2,2), . . . , (iN,N)}
where 1=i1, . . . , iN=m is satisfied.

Accordingly, what is stored in the seeder 52 while keeping the encrypted pieces in correspondence with the indexes can be expressed as below, for example:
{(E(K(i1,1)) [C1], (i1,1)), E(K(i2,2)) [C2], (i2,2)), . . . , E(K(iN,N)) [CN], (iN,N))}
where 1=i1, . . . , iN=m is satisfied.

Further, the seeder 52A, which is an initial seeder, stores therein all the encrypted pieces that have been generated by encrypting each of the encrypted pieces that respectively correspond to the pieces constituting the content, by using the plurality of encryption keys per piece. FIG. 4 is a diagram illustrating an example of the encrypted pieces stored in the seeder 52A. In FIG. 4, it is indicated that, of the N pieces, each of as many pieces as “a” (where 1<a<N) is encrypted by using the plurality of mutually different encryption keys per piece. In the example shown in FIG. 4, the number of encryption keys used for encrypting each piece is different for the different pieces. The number of encryption keys used for encrypting the piece C1 is m, whereas the number of encryption keys used for encrypting the piece C3 is two. According to the present embodiment, however, another arrangement is acceptable in which the number of encryption keys used for encrypting each piece is the same for all of the pieces. In a piece processing apparatus, with this arrangement where, of the N pieces, each of as many pieces as “a” (where 1<a<N) is encrypted by using the plurality of mutually different encryption keys per piece, it is possible to have a configuration so that, for example, the higher the level of importance is, the larger the number of encryption keys is.

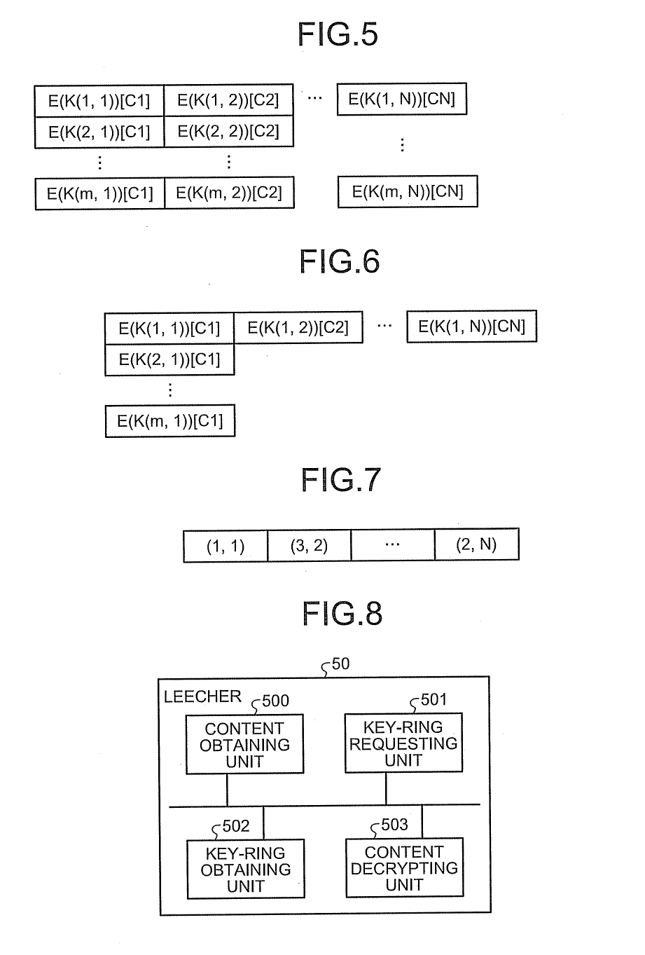

The present embodiment is not limited to the example described above. For example, another arrangement is acceptable in which “a=N” is satisfied as shown in FIG. 5, so that each of all the N pieces is encrypted by using as many mutually different encryption keys as “m” per piece. With this arrangement, it is possible to increase the number of variations of the sequence of the encrypted pieces. Further, yet another arrangement is acceptable in which “a=1” is satisfied as shown in FIG. 6, so that only one of the N pieces is encrypted with as many mutually different encryption keys as “m”. With this arrangement, it is possible to improve the level of distribution efficiency.

In the configuration as described above, when being accessed by the leecher 50, the seeder 52 transmits piece information to the leecher 50, the piece information indicating the sequence of the encrypted pieces stored in the seeder 52. FIG. 7 is a diagram illustrating an example of a data structure of the piece information. In FIG. 7, it is indicated that the encrypted piece corresponding to the piece C1 is to be decrypted with a decryption key K(1,1), whereas the encrypted piece corresponding to the piece C2 is to be decrypted with a decryption key K(3,2). In other words, the piece information indicates the correspondence relationship between the encrypted pieces and the decryption keys each of which is used for decrypting a different one of the encrypted pieces. When having received a piece request from the leecher 50 requesting an encrypted piece based on the piece information, the seeder 52 judges whether the requested encrypted piece is stored therein. In the case where the result of the judging process is in the affirmative, the seeder 52 transmits the requested encrypted piece to the leecher 50.

Next, various types of functions that are realized in the hardware configuration described above when the CPU of the leecher 50 executes the various types of programs stored in the storage devices and the external storage devices will be explained. FIG. 8 is an exemplary functional diagram of the leecher 50. The leecher 50 includes a content obtaining unit 500, a key-ring requesting unit 501, a key-ring obtaining unit 502, and a content decrypting unit 503. The actual substance of each of these constituent elements is generated in a storage device (e.g., the RAM) when the CPU executes the programs.

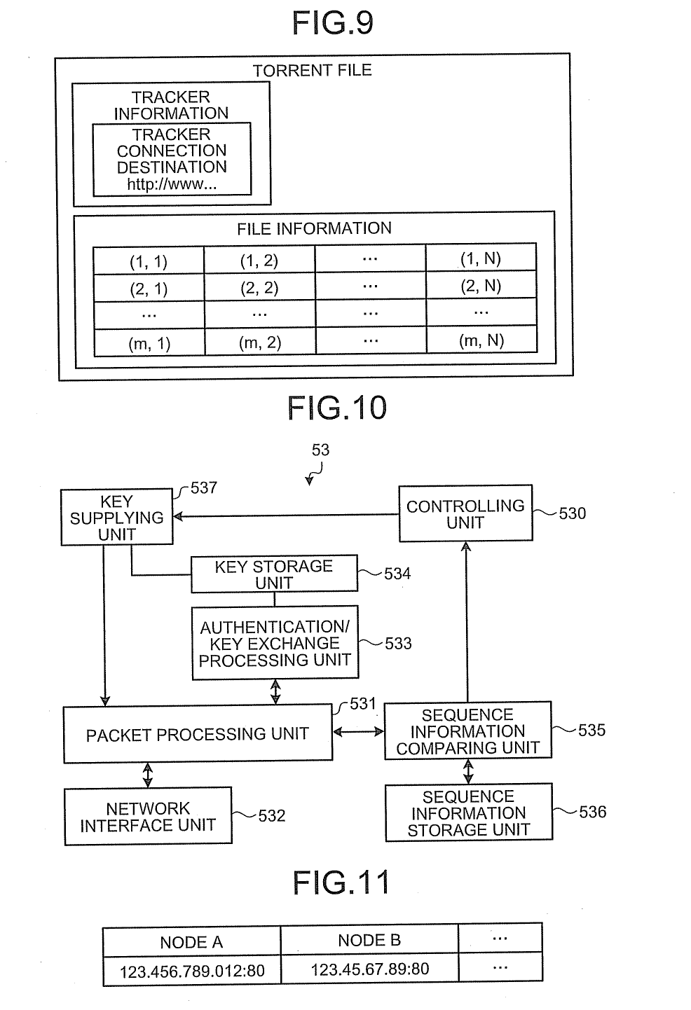

The content obtaining unit 500 receives the encrypted pieces that constitute the encrypted content from at least one of the seeders 52, via the P2P network NT. More specifically, the content obtaining unit 500 first receives a Torrent File from the sales server 54. The Torrent File contains tracker information including tracker connection destination information used for connecting to the tracker 51 and file information indicating what encrypted pieces constitute the encrypted content. FIG. 9 is a diagram illustrating an example of the Torrent File. In FIG. 9, as for the file information, the indexes corresponding to the encrypted pieces are shown as the information used for identifying each of the encrypted pieces. The tracker connection destination information may be, for example, an IP address or a Uniform Resource Locator (URL) of the tracker 51.

Based on the Torrent File, the content obtaining unit 500 accesses the tracker 51 via the P2P network NT and receives, from the tracker 51, node information used for accessing the other nodes (e.g., the seeders 52 and other leechers 50) connected to the P2P network NT. (The node information will be explained in detail later.) After that, based on the node information, the content obtaining unit 500 accesses at least one of the nodes and obtains piece information indicating the sequence of encrypted pieces stored in the node. Based on the piece information, the content obtaining unit 500 then transmits a piece request to at least one of the nodes to request one or more of the encrypted pieces that constitute the encrypted content. By receiving the encrypted pieces that are transmitted in response to the piece request, the content obtaining unit 500 obtains all the encrypted pieces (hereinafter, the “piece sequence”) that constitute the encrypted content. For example, of the encrypted pieces shown in FIG. 3, the content obtaining unit 500 obtains all the encrypted pieces that are shown with hatching as the piece sequence. The content obtaining unit 500 stores the obtained encrypted pieces into, for example, an external storage device.

The key-ring requesting unit 501 transmits a request message to the key server 53 to request a key-ring used for decrypting the piece sequence. The key-ring contains the decryption keys used for decrypting the encrypted pieces in the piece sequence in correspondence with the sequence of the encrypted pieces. The key-ring and the decryption keys will be explained in detail later. The request message contains index information as information that specifies the sequence of the decryption keys contained in the key-ring, the index information indicating the combination (i.e., the sequence) of the indexes of the encrypted pieces in the piece sequence.

For example, the sequence can be expressed as below:
{(i1,1), (i2,2), . . . , (iN,N)}
where 1=i1, . . . , iN=m is satisfied.

The key-ring obtaining unit 502 receives the key-ring that has been transmitted from the key server 53 in response to the request message. The content decrypting unit 503 decrypts the encrypted pieces that have been obtained by the content obtaining unit 500, with the decryption keys that are contained in the key-ring obtained by the key-ring obtaining unit 502 and that correspond to the encrypted pieces respectively. The content decrypting unit 503 thus obtains the content that is constituted with the pieces resulting from the decryption process.

There is a situation in which the leecher 50 functions as a seeder, as explained above; however, because the functional configuration of a seeder has already been explained in the description of the seeder 52, the explanation thereof will be omitted.

Next, various types of functions that are realized when the CPU of the key server 53 executes the various types of programs stored in the storage devices and the external storage devices will be explained. FIG. 10 is an exemplary functional diagram of the key server 53. The key server 53 includes a controlling unit 530, a packet processing unit 531, a network interface unit 532, an authentication/key exchange processing unit 533, a key storage unit 534, a sequence information storage unit 536, a sequence information comparing unit 535, and a key supplying unit 537. The actual substance of each of the units such as the controlling unit 530, the sequence information comparing unit 535, the network interface unit 532, the packet processing unit 531, the authentication/key exchange processing unit 533, and the key supplying unit 537 is generated in a storage device (e.g., the RAM) when the CPU executes the programs. The key storage unit 534 is, for example, stored in an external storage device.

The controlling unit 530 controls the entirety of the key server 53 and also intermediates instructions from the sequence information comparing unit 535 to the key supplying unit 537. The packet processing unit 531 packetizes various types of data to be transmitted to external apparatuses such as a leecher 50 and forwards the packet to the network interface unit 532. The packet processing unit 531 also obtains data, based on packets forwarded from the network interface unit 532. The network interface unit 532 controls communication with external apparatuses, transmits the packetized data forwarded from the packet processing unit 531 to the external apparatuses, and forwards the packets received from the external apparatuses to the packet processing unit 531.

The authentication/key exchange processing unit 533 receives the request message from the leecher 50 via the network interface unit 532, performs a mutual authentication process with the leecher 50, and, after the authentication process has been finished, transmits an acceptance message to the leecher 50 so as to indicate that the request has been accepted.

The key storage unit 534 is provided in, for example, an external storage device such as an HDD and stores therein the decryption keys used for decrypting the encrypted pieces. Each of the decryption keys is expressed as, for example, K(i,j), as explained above.

The sequence information storage unit 536 is provided in, for example, an external storage device such as an HDD and stores therein sequence information indicating the sequences that respectively correspond to all the key-rings that were transmitted to the leechers 50 in the past. For example, the sequences that respectively correspond to the key-rings can be expressed as below, like the sequences indicated in the index information described above:
{(i1,1), (i2,2), . . . , (iN,N)}
where 1=i1, . . . , iN=m is satisfied.

The sequence information comparing unit 535 compares the sequence information stored in the sequence information storage unit 536 with the index information received from the leecher 50 and determines whether the key-ring corresponding to the sequence indicated in the index information should be transmitted. More specifically, in the case where the sequence information storage unit 536 stores therein no sequence information indicating the same sequence as the sequence indicated in the index information, the sequence information comparing unit 535 determines that the key-ring corresponding to the sequence indicated in the index information should be transmitted. For example, the key-ring can be expressed as below (In the example below, the decryption keys that respectively correspond to the pieces C1 to CN are arranged in a row from the left side):
{K(i1,1), K(i2,2), . . . , K(iN,N)}
where 1=i1, . . . , iN=m is satisfied.

In the case where the sequence information comparing unit 535 has determined that the key-ring should be transmitted, the sequence information comparing unit 535 instructs, via the controlling unit 530, the key supplying unit 537 to transmit the key-ring to the leecher 50. On the contrary, in the case where the sequence information comparing unit 535 has determined that the key-ring should not be transmitted, the sequence information comparing unit 535 instructs, via the controlling unit 530, the key supplying unit 537 that the transmission of the key-ring to the leecher 50 is prohibited.

According to the instruction received from the sequence information comparing unit 535 via the controlling unit 530 instructing that the key-ring should be transmitted, the key supplying unit 537 reads the decryption keys that correspond to the sequence of the key-ring out of the key storage unit 534 and transmits the key-ring that contains the read decryption keys to the leecher 50 via the network interface unit 532.

Next, a configuration of the tracker 51 will be explained. When being accessed by the leecher 50, the tracker 51 transmits the node information to the leecher 50, the node information being used as connection destination information for accessing the nodes connected to the P2P network NT. The node information contains sets each made up of an IP address and a port number of a different one of the nodes. FIG. 11 is a diagram illustrating an example of a data structure of the node information. In FIG. 11, each of the nodes A and B is any one of the leechers 50A and 50B and the seeders 52A, 52B, and 52C, and a set made up of the IP address and the port number is shown for each of the nodes. Also, the tracker 51 transmits the invalid piece list explained above to the leecher 50.

Next, how the tracker 51 generates the node information will be explained. For example, it is assumed that, in the case where there are a plurality of trackers 51, a node stores therein a Torrent File containing the tracker connection destination information used for connecting to one of the trackers 51 and also stores therein encrypted pieces. The node refers to the tracker connection destination information contained in the Torrent File and transmits node identification information that uniquely identifies the node to the tracker 51. The node identification information may be, for example, an IP address and a port number of the node. When having received the node identification information, the tracker 51 generates the node information as shown in FIG. 11, by using the received node identification information.

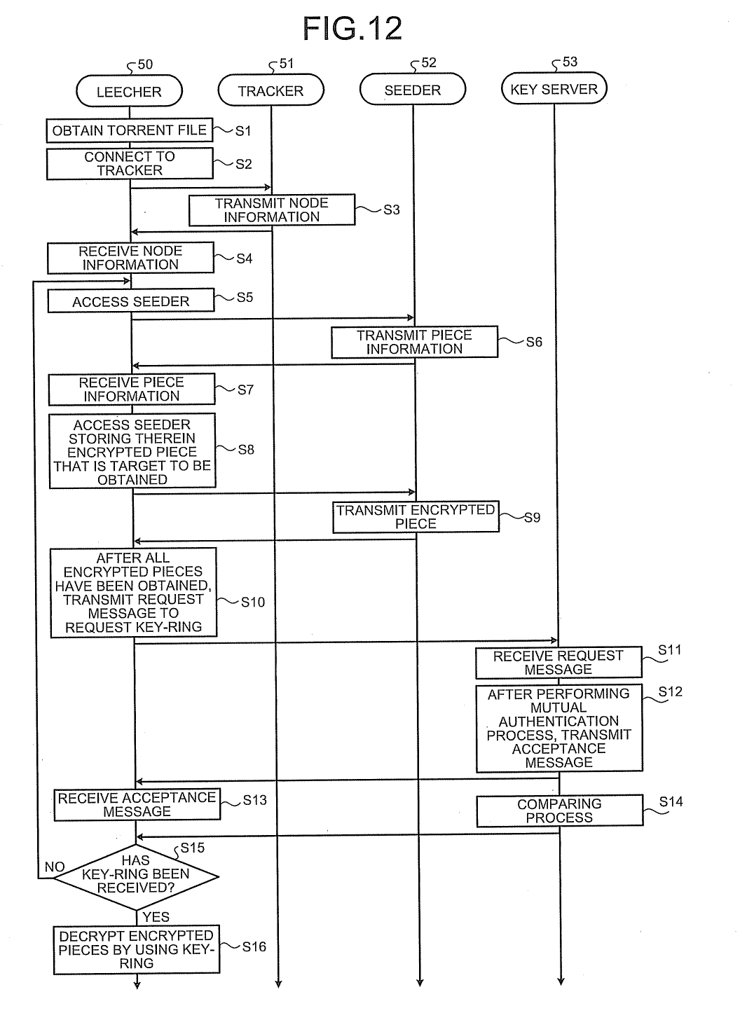

Next, a basic procedure in a content distributing process performed in the content distribution system according to the first embodiment will be explained, with reference to FIG. 12. The leecher 50 is able to receive encrypted pieces from any of the other leechers 50; in the following explanation, however, for the sake of convenience of the explanation, it is assumed that the leecher 50 receives the encrypted pieces from at least one of the seeders 52A, 52B, and 52C.

First, the leecher 50 accesses the sales server 54 and obtains the Torrent File (step S1). After that, the leecher 50 accesses the tracker 51 by using the tracker connection destination information included in the tracker information contained in the Torrent File (step S2). The tracker 51 then transmits the node information to the leecher 50 (step S3). When the leecher 50 has received the node information (step S4), the leecher 50 accesses, for example, at least one of the seeders 52A, 52B, and 52C by using the node information (step S5). When the seeder 52 is accessed by the leecher 50, the seeder 52 transmits the piece information to the leecher 50 so as to indicate the sequence of the encrypted pieces stored therein (step S6).

When the leecher 50 has received the piece information (step S7), the leecher 50 accesses at least one of the seeders 52 by using the piece information (step S8). The leecher 50 transmits a piece request to the seeder 52 to request, for each of the pieces C1 to CN, at least one of the plurality of encrypted pieces that can possibly exist in correspondence with the piece, so that the leecher 50 is able to receive the encrypted pieces. In response to the piece request from the leecher 50, the seeder 52 transmits the encrypted piece stored therein to the leecher 50 (step S9). More specifically, for example, by using the piece information that has been received by accessing the seeder 52B, the leecher 50 judges whether the seeder 52B stores therein the encrypted piece corresponding to “i1=1” among the encrypted pieces E(K(i1,1)) [C1] (where i1 is an integer that satisfies 1=i1=m) obtained by encrypting the piece C1. In the case where the result of the judging process is in the affirmative, the leecher 50 accesses the seeder 52B and obtains the encrypted piece E(K(1,1)) [C1] by receiving it from the seeder 52B. In the case where the seeder 52B actually does not store therein the encrypted piece E(K(1,1)) [C1], the leecher 50 subsequently accesses another seeder 52 (e.g., the seeder 52C) and obtains piece information from the another seeder (e.g., the seeder 52C). In the same manner as described above, by using the piece information, the leecher 50 judges whether the seeder 52C stores therein the encrypted piece. In the case where the result of the judging process is in the affirmative, the leecher 50 accesses the seeder 52C and attempts to obtain the encrypted piece. By repeating the process described above, the leecher 50 obtains the encrypted content {E(K(i1,1)) [C1], E(K(i2,2)) [C2], . . . , E(K(iN,N)) [CN]} that is constituted with the encrypted pieces.

As the target to be obtained, the leecher 50 is able to arbitrarily select any one of the plurality of encrypted pieces that can possibly exist in correspondence with a piece Cj (where 1=j=N). In other words, with regard to E(K(i1,j)) [Cj] (where i1 is an integer that satisfies 1=i1=m), the leecher 50 is able to arbitrarily set “i1” to any one of the values from “1” to “m”. Accordingly, the sequence of the encrypted pieces {(i1,1), (i2,2), . . . , (iN,N)} that have been obtained by the leecher 50 in correspondence with the pieces C1 to CN is arbitrary.

In the case where it has been judged that the leecher 50 is not able to completely receive the encrypted piece transmitted at step S9, an arrangement is acceptable in which the leecher 50 returns to one of the steps before step S9 and starts the process all over again. It is judged that the leecher 50 is not able to completely receive the transmitted encrypted piece in the case where, for example, the leecher 50 has received an encrypted piece or a part of a specific encrypted piece, but the number of times the leecher 50 has attempted to obtain it and failed to do so has exceeded a predetermined threshold value, or the period of time that has elapsed since the start of the obtaining process has exceeded a predetermined threshold value.

When the leecher 50 has obtained all the encrypted pieces that respectively correspond to the pieces constituting the content and that constitute the encrypted content, the leecher 50 transmits the request message to the key server 53 to request the key-ring that contains the decryption keys used for decrypting the encrypted pieces (step S10). The request message contains the index information {(i1,1), . . . , (iN,N)} indicating the sequence corresponding to the decryption keys.

When the authentication/key exchange processing unit 533 included in the key server 53 has received the request message via the network interface unit 532 (step S11), the authentication/key exchange processing unit 533 performs a mutual authentication process with the leecher 50. In the case where the authentication process has been performed successfully, the authentication/key exchange processing unit 533 transmits an acceptance message to the leecher 50 to indicate that the request has been accepted (step S12). When the leecher 50 has received the acceptance message from the key server 53 (step S13), the leecher 50 waits for the key-ring to be transmitted from the key server 53.

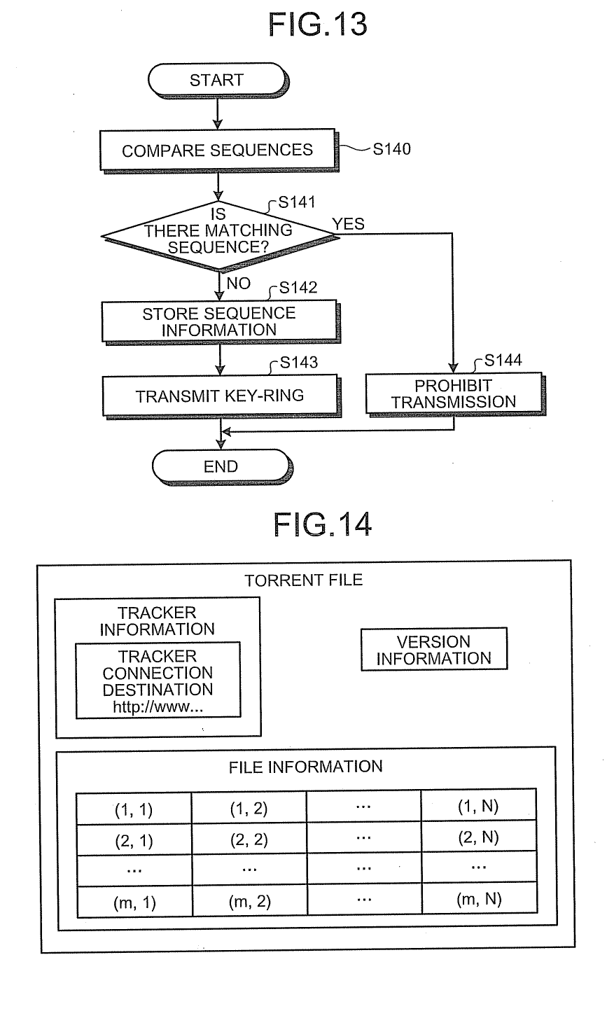

On the other hand, the sequence information comparing unit 535 included in the key server 53 performs a comparing process by using the index information contained in the request message that has been received at step S11 (step S14). FIG. 13 is a flowchart of a procedure in the comparing process. In the comparing process, the sequence information comparing unit 535 compares the index information contained in the request message that has been received at step S11 with the sequence information stored in the sequence information storage unit 536 (step S140) and judges whether the sequence information storage unit 536 stores therein sequence information indicating the same sequence as the sequence indicated in the index information (step S141). In other words, the sequence information comparing unit 535 judges whether the key-ring requested by the leecher 50 was transmitted to any of the leechers 50 in the past.

In the case where the result of the judging process is in the negative (step S141: No), the sequence information comparing unit 535 determines that the key-ring {K(i1,1), K(i2,2), . . . , K(iN,N)} corresponding to the sequence indicated in the index information should be transmitted. Thus, the sequence information comparing unit 535 instructs, via the controlling unit 530, the key supplying unit 537 to transmit the key-ring to the leecher 50. In addition, the sequence information comparing unit 535 stores sequence information indicating the sequence into the sequence information storage unit 536 (step S142). The key supplying unit 537 reads the key-ring of which the transmission has been instructed by the sequence information comparing unit 535 via the controlling unit 530 out of the key storage unit 534 and transmits the read key-ring to the leecher 50 via the network interface unit 532 (step S143). On the contrary, in the case where the result of the judging process at step S141 is in the affirmative, the sequence information comparing unit 535 determines that the key-ring should not be transmitted and instructs, via the controlling unit 530, the key supplying unit 537 that the transmission of the key-ring to the leecher 50 is prohibited (step S144). Returning to the description of FIG. 12, in the case where the leecher 50 has received the key-ring {K(i1,1), K(i2,2), . . . , K(iN,N)} from the key server 53 (step S15: Yes), the leecher 50 decrypts the encrypted pieces E(K(i1,1)) [C1], E(K(i2,2)) [C2], . . . , E(K(iN,N)) [CN] by using the decryption keys contained in the key-ring so as to obtain the decrypted pieces C1 to CN and obtain the content C constituted with the pieces C1 to CN (step S16). In other words, the leecher 50 decrypts E(K(i1,1)) [C1] by using the decryption key K(i1,1) and obtains the piece C1, decrypts E(K(i2,2)) [C2] by using the decryption key K(i2,2) and obtains the piece C2, and decrypts E(K(iN,N)) [CN] by using the decryption key K(iN,N) and obtains the piece CN. The leecher 50 obtains the other pieces in the same manner. Thus, the leecher 50 has obtained the content C that is constituted with the pieces C1 to CN.

On the contrary, in the case where the leecher 50 does not receive the key-ring at step S15 and has received an error message transmitted from the key server 53 at step S143 shown in FIG. 13, the leecher 50 is not able to decrypt the pieces that have been obtained at step S10 and is therefore not able to use the content. In this situation, the process returns to step S5, so that the leecher 50 obtains encrypted pieces in a sequence that is different from the sequence obtained at step S10 and performs the processes at step S10 and thereafter again.

As explained above, in the case where the one content is distributed to the plurality of leechers 50 via the P2P network, the key server 53 determines whether the key-rings should be transmitted by using the sequences of the encrypted pieces. In this situation, because the key server 53 avoids re-using the sequences that have already been used, it is possible to individualize the content for each of the leechers 50. Accordingly, for example, even if one key-ring is leaked, it is possible to decrypt only the encrypted content that corresponds to the leaked key-ring. Thus, it is possible to inhibit illegitimate use of the content. In addition, by using, instead of a predetermined sequence, the sequence defined by the encrypted pieces that are arbitrarily obtained by the leecher 50, it is possible to realize a flexible content distributing process that is compliant with the environment of the P2P network.

Next, a configuration that is added to the basic configuration of the content distribution system described above and with which the first embodiment is characterized will be explained. In this configuration, the encrypted pieces and the decryption keys K(i,j) are updated over the course of time. In the following section, for the sake of convenience of the explanation, an example in which the encryption keys are respectively the same as the decryption keys will be explained. As explained above, it is acceptable if the encryption keys are different from the decryption keys, respectively; however, in this situation, both the encryption keys and the decryption keys are updated. For example, let us discuss an example in which the piece processing apparatus explained above generates encrypted pieces as shown in FIG. 5. When a predetermined period of time V has elapsed since the encrypted pieces are generated, the piece processing apparatus generates new decryption keys so as to generate a key-ring K′(i,j) (where i=1, . . . m, and j=1, . . . , N are satisfied). The piece processing apparatus performs an encrypting process by using the new decryption keys (i.e., the new encryption keys) so as to generate encrypted pieces E(K′(i,j)) [Cj] the total quantity of which is equal to mN and forwards the generated encrypted pieces to the initial seeder 52A. In addition, the piece processing apparatus generates a new Torrent File that contains file information indicating the encrypted pieces E(K′(i,j)) [Cj] that have newly been generated and the total quantity of which is equal to mN and forwards the newly-generated Torrent File to the sales server 54 and to the initial seeder 52A. In the case where the piece processing apparatus is not the key server 53, the piece processing apparatus also forwards the newly-generated Torrent File to the key server 53. Further, the piece processing apparatus informs the tracker 51 that the encrypted pieces have been updated.

Next, a configuration of the Torrent File that is generated by the piece processing apparatus will be explained. FIG. 14 is a drawing illustrating an example of the Torrent File. The Torrent File in this exemplary configuration contains version information, in addition to the configuration of the Torrent File shown in FIG. 9. The version information is information that indicates the Torrent File's version that is updated every time the Torrent File is updated. The version information serves as version management information with which it is possible to judge whether the Torrent File has validity. The piece processing apparatus updates the value of the version information every time the encrypted pieces and the decryption keys are updated, generates a Torrent File containing the version information of which the value has been updated, together with file information indicating the updated encrypted pieces, and forwards the generated Torrent File to the sales server 54 and to the initial seeder 52A. When a Torrent File has validity (i.e., a Torrent File is valid), it means that the encrypted pieces indicated in the file information are valid and that the decryption keys used for decrypting the encrypted pieces are valid. When decryption keys are valid, it means that the decryption keys have not been invalidated due to, for example, a disclosure and that the key server 53 is able to transmit these decryption keys when being requested by the leecher 50. Accordingly, by judging whether a Torrent File has validity, it is possible to judge whether the encrypted pieces indicated in the file information therein have validity and whether the decryption keys used for decrypting the encrypted pieces have validity. It should be noted that, in the present example, the processes are performed on an assumption that only the Torrent File that contains the most updated version information of which the value has been updated by the piece processing apparatus is valid.

Next, an additional function of the leecher 50 that is further provided in this configuration, in addition to the basic functions of the leecher 50 described above will be explained. The key-ring requesting unit 501 included in the leecher 50 obtains the version information contained in the Torrent File that has been obtained by the content obtaining unit 500 and has been used to obtain the encrypted pieces, puts the obtained version information and the index information into the request message described above, and transmits the request message to the key server 53.

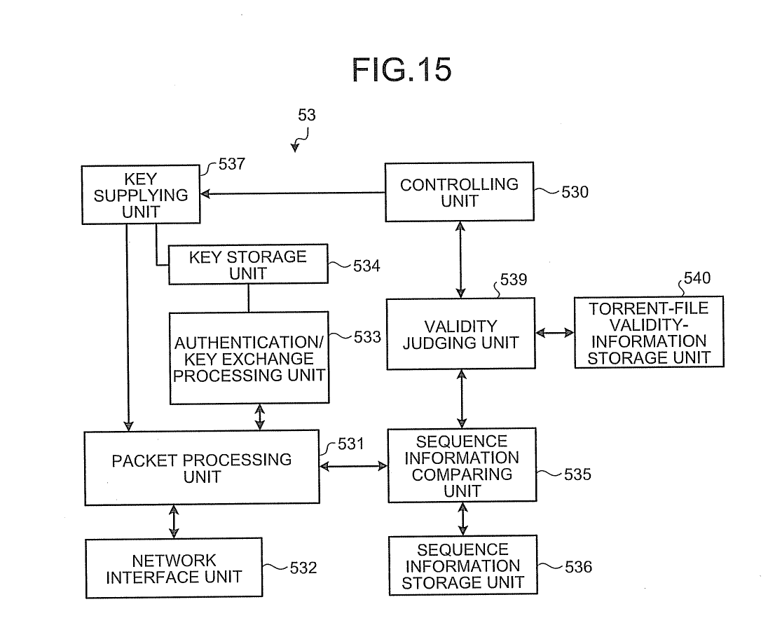

Next, an additional function of the key server 53 that is further provided in addition to the basic functions of the key server 53 described above will be explained. FIG. 15 is an exemplary functional diagram of the key server 53 in this configuration. In this configuration, the key server 53 further includes a validity judging unit 539 and a Torrent-File validity-information storage unit 540. The Torrent-File validity-information storage unit 540 stores therein validity information used for identifying the version information of the valid Torrent File. In this situation, the validity information is information that indicates the most updated version information. In the case where the piece processing apparatus is the key server 53, the key server 53 generates the version information and stores the validity information into the Torrent-File validity-information storage unit 540. On the contrary, in the case where the piece processing apparatus is not the key server 53, the key server 53 obtains the validity information from the piece processing apparatus and stores the obtained validity information into the Torrent-File validity-information storage unit 540. The validity judging unit 539 compares the version information contained in the request message that has been received by the authentication/key exchange processing unit 533 with the validity information stored in the Torrent-File validity-information storage unit 540 and judges whether the key-ring that has been requested by the leecher 50 has validity. According to the result of the judging process performed by the validity judging unit 539, the sequence information comparing unit 535 compares the index information with the sequence information in the same manner as described above.

Next, a procedure in a content distributing process performed in the content distribution system according to the first embodiment will be explained, with reference to FIG. 12. At step S1, the leecher 50 accesses the sales server 54 and obtains a Torrent File, in the same manner as described above. It should be noted that every time the leecher 50 performs the process at step S1, the leecher 50 obtains the most updated Torrent File. The processes performed at steps S2 through S9 are the same as those according to the basic configuration described above. At step S10, the leecher 50 transmits, to the key server 53, a request message that contains the version information contained in the Torrent File that has been obtained at step S1 and has been used to obtain the encrypted pieces. For example, in the case where the version information of the Torrent File is mutually the same for all the encrypted pieces, the leecher 50 transmits, to the key server 53, a request message that indicates a combination of version information and index information as shown below:
{Version, (i1,1), (i2,2), . . . , (iN,N)}
where 1=i1, . . . , iN=m is satisfied, and “Version” denotes the version information of the Torrent File.

There is a possibility that the leecher 50 may have performed the process at step S1 a plurality of times and may have obtained a plurality of mutually different Torrent Files from the sales server 54 so that the leecher 50 obtains the encrypted pieces by using the plurality of Torrent Files. In this situation, for example, the leecher 50 puts a combination of pieces of version information of the Torrent Files corresponding to the encrypted pieces and pieces of index information corresponding to the pieces of version information, as shown below, into the request message and transmits the request message to the key server 53.
{(i1,1, Version_{—}1), (i2,2, Version_{—}2), . . . , (iN,N, Version_N)}

The notation “Version_i” (where1=i=N is satisfied) denotes the version information of the Torrent File corresponding to each of the encrypted pieces. The versions expressed by “Version i” may be different from one another. Alternatively, two or more of the versions expressed by “Version i” may be the same as one another.

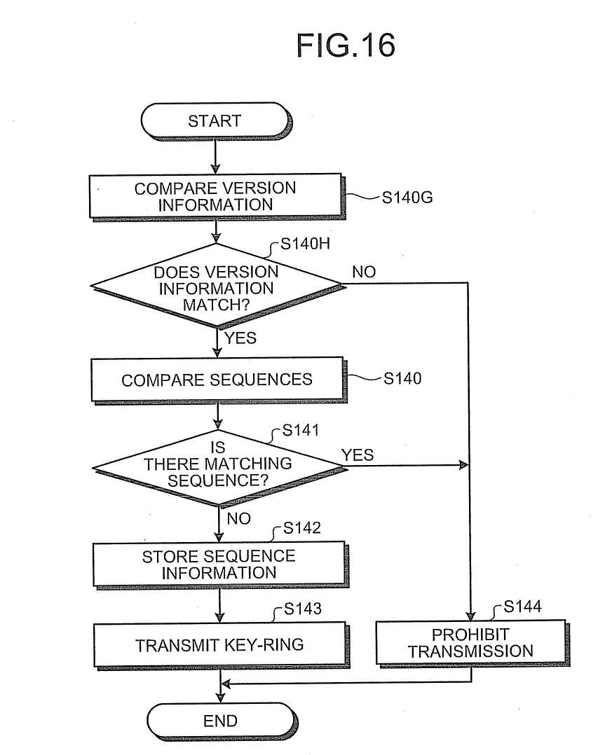

After that, the processes performed at steps S11 through S13 are the same as those according to the basic configuration described above. At step S14, the key server 53 performs a comparing process as described below. FIG. 16 is a flowchart of a procedure in the comparing process according to the first embodiment. The validity judging unit 539 included in the key server 53 compares the version information contained in the request message with the validity information stored in the Torrent-File validity-information storage unit 540 (step S140G). By judging whether the version information and the validity information match, the validity judging unit 539 judges whether the key-ring requested in the request message is valid (step S140H). In other words, in this situation, only the decryption keys that are used for decrypting the encrypted pieces indicated in the file information contained in the Torrent File having the most updated version information are judged to be valid. In the case where the request message contains a plurality of pieces of version information, the validity judging unit 539 performs the judging process at step S140H for each of the pieces of version information. In the case where the results of the judging process for all the pieces of version information are in the affirmative, the validity judging unit 539 judges that all the decryption keys contained in the requested key-ring are valid and that the key-ring is valid. After that, the sequence information comparing unit 535 performs the processes at step S140 and thereafter in the same manner as described above. On the contrary, in the case where the result of the judging process at step S140H for at least one of the pieces of version information is in the negative, the validity judging unit 539 judges that the decryption keys that are identified by the index information corresponding to such version information are invalid and that the key-ring containing the decryption keys is invalid. In this situation, the sequence information comparing unit 535 performs the process at step S144 in the same manner as described above.

As explained above, by occasionally updating the encrypted pieces and the key-ring, it is possible to inhibit the illegitimate action where a user collects all the encrypted pieces and a key-ring and discloses all of them by using a certain method so as to allow another user to illegitimately use the content. The reason is that, before the user attempting to take the illegitimate action has obtained all the encrypted pieces, it becomes difficult for the user to find the desired encrypted pieces in the network. In other words, once every predetermined period of time, a new set of encrypted pieces is stored in each of the seeders 52 or the set of encrypted pieces stored in each of the seeders is replaced by a new set of encrypted pieces. Thus, even if the user attempts to obtain a set of encrypted pieces that corresponds to an outdated key-ring, the user may not be able to find those encrypted pieces. Thus, it is possible to effectively inhibit illegitimate use of the content that may harmfully be caused by such an illegitimate action.

According to the first embodiment, the Torrent File is not limited to the example described above. For example, another arrangement is acceptable in which the file information contains hash values that are calculated through a hash calculation process by using the encrypted pieces. For example, the hash values of the encrypted pieces can be expressed as below:
{hash(E(K(i,j)) [Cj])}
where 1=i=m and 1=j=N are satisfied.

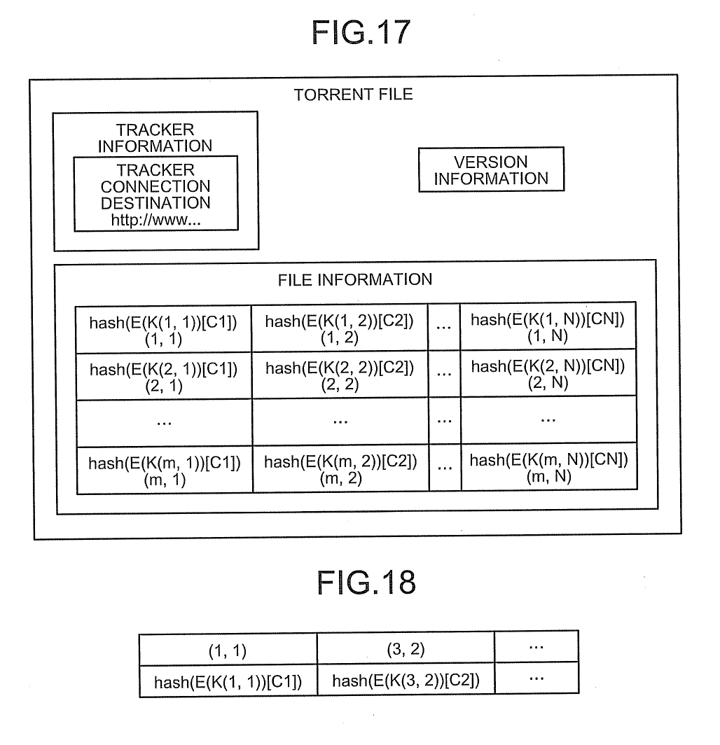

FIG. 17 is a drawing illustrating an example of a data structure of such a Torrent File. In FIG. 17, the correspondence relationships between the hash values of the encrypted pieces and the indexes are shown. The leecher 50 is able to check the completeness of the received encrypted pieces, by using the hash values of which there are as many as m×n. Further, yet another arrangement is acceptable in which the creator of the Torrent File or a reliable third party (e.g., a content creator) attaches a digital signature to the Torrent File. In this situation, the leecher 50 is able to check authenticity of the received encrypted pieces, in addition to the completeness thereof.

Also, by referring to such a Torrent File, it is possible to identify the index based on the hash value of each of the encrypted pieces. As a result, it is also possible to identify the decryption key used for decrypting the encrypted piece.

In this configuration, yet another arrangement is acceptable in which the seeder 52 further transmits piece information containing hash values to the leecher 50. FIG. 18 is a drawing illustrating an example of index information containing the hash values. In this situation also, the leecher 50 is able to check the completeness of the received encrypted pieces by using the hash values.

The file information does not need to show all the indexes. (In the example described above, the file information shows all combinations of (i,j) that satisfy 1=i=m and 1=j=N). It is acceptable if the file information shows only a part of the indexes.

In the first embodiment described above, the version management information may be information that shows the time at which the Torrent File was generated or may be a hash value that is calculated through a hash calculation process by using the Torrent File. Further, the version management information may be a combination of two or more of the information showing the time, the hash value, and the version information. In this situation, the Torrent-File validity-information storage unit 540 stores therein, as the validity information used for identifying the version management information of the valid Torrent File, information that shows the time at which the most updated Torrent File was generated or information that shows the hash value calculated through a hash calculation process by using the most updated Torrent File. After that, the key server 53 judges whether the key-ring requested in the request message transmitted from the leecher 50 is valid by using the validity information, in the same manner as described in the first embodiment.

In the first embodiment, the leecher 50 puts the version information of the Torrent File into the request message; however, another arrangement is acceptable in which, instead of the version information, the leecher 50 puts hash values of the encrypted pieces indicated in the file information contained in the Torrent File into the request message and transmits the request message. In this situation, the hash values are used as the version management information with which it is possible to judge the validity of the Torrent File. In this situation, the Torrent File obtained by the leecher 50 does not necessarily have to contain any version information. Also, in this situation, as explained in one of the modification examples of the first embodiment, it is assumed that the file information in the Torrent File contains the hash information of the encrypted pieces. The leecher 50 refers to the file information in the Torrent File and puts the hash values of the encrypted pieces for which the decryption keys are requested into the request message and transmits the request message to the key server 53. Another arrangement is acceptable in which the file information in the Torrent File does not contain the hash information of the encrypted pieces, but the leecher 50 calculates the hash values of the obtained encrypted pieces, puts the calculated hash values into the request message, and transmits the request message.

In any of the situations described above, the Torrent-File validity-information storage unit 540 included in the key server 53 stores therein, in advance, the hash values of the encrypted pieces that are indicated in the file information contained in the valid Torrent File. The validity judging unit 539 compares the hash values contained in the request message with the hash values stored in the Torrent-File validity-information storage unit 540. In the case where all the hash values contained in the request message have the matching hash values stored, the validity judging unit 539 judges that the requested key-ring is valid. On the contrary, in the case where one or more of the hash values contained in the request message do not have the matching hash values stored in the Torrent-File validity-information storage unit 540, the validity judging unit 539 judges that the requested key-ring is invalid. In this situation, an arrangement is acceptable in which the key server 53 is configured so as to transmit a message to the leecher 50 to indicate that the requested key-ring is invalid. Yet another arrangement is acceptable in which the key server 53 informs the leecher 50 of one or more encrypted pieces that are to be decrypted by using invalid decryption keys, by transmitting, to the leecher 50, index information corresponding to one or more hash values of which the matching hash values are not stored in the Torrent-File validity-information storage unit 540.

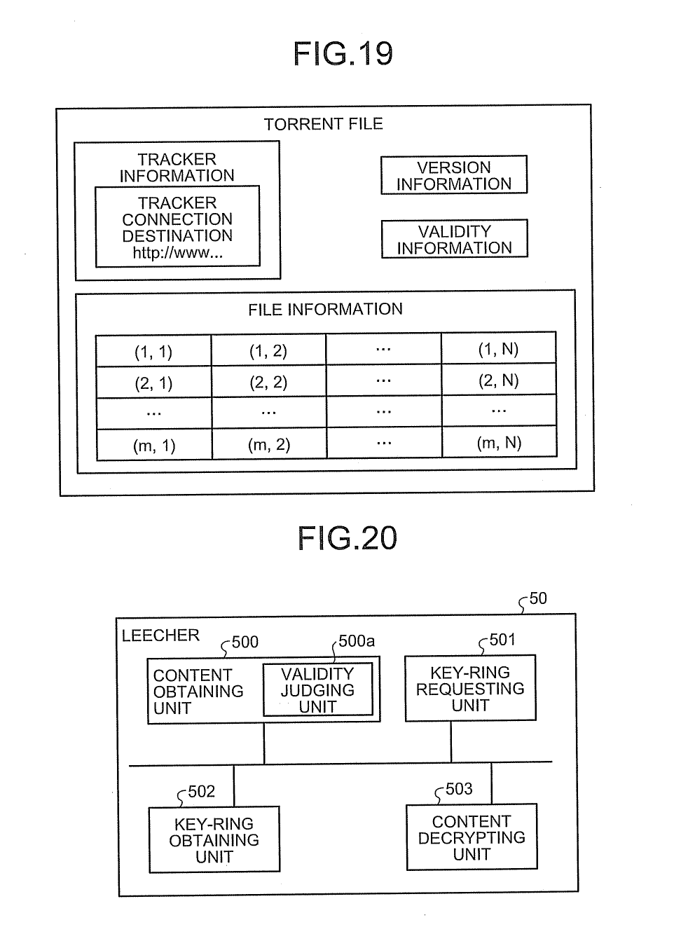

In the first embodiment described above, another arrangement is acceptable in which the Torrent File contains validity information used for identifying the version information of valid Torrent Files, in addition to the version information. FIG. 19 is a drawing illustrating an example of the Torrent File according to the present modification example. The validity information is, for example, information that indicates the version information of the valid Torrent Files. For example, let us discuss an example in which the version information of the Torrent File for a certain content has been updated from “1” to “5” sequentially. An arrangement is acceptable in which, in the case where the version information of the valid Torrent Files are “3”, “4”, and “5”, the validity information indicates “3”, “4”, and “5” as the version information of the valid Torrent Files. Another arrangement is acceptable in which the validity information is information that specifies a range of the version information of the valid Torrent Files. In this situation, because the range of the version information of the valid Torrent Files is “3” or larger, an arrangement is acceptable in which the validity information indicates only “3”. Yet another arrangement is acceptable in which the validity information is configured so as to indicate a list or a range of the version information of the Torrent Files containing the file information that indicates the encrypted pieces to be decrypted by invalid decryption keys. With this configuration, it is possible to identify that the Torrent Files other than the ones identified in the list or the range of the version information indicated in the validity information are valid.

There is no particular limitation in deciding which Torrent Files at which points in time are valid. Also, another arrangement is acceptable in which every time the encrypted pieces and the decryption keys are updated, the decision regarding which Torrent Files at which points in time are valid is changed.

In this configuration, the Torrent-File validity-information storage unit 540 included in the key server 53 stores therein validity information used for identifying the Torrent Files that are valid at the current point in time, instead of the validity information described above. In the case where the piece processing apparatus is the key server 53, the key server 53 generates the validity information and stores the generated validity information into the Torrent-File validity-information storage unit 540 each time. In the case where the piece processing apparatus is not the key server 53, the key server 53 obtains the validity information from the piece processing apparatus each time and stores the obtained validity information into the Torrent-File validity-information storage unit 540.

At step S140G, instead of comparing the version information with the validity information, the key server 53 judges whether the version information contained in the request message is included in the list or the range of version information indicated in the validity information stored in the Torrent-File validity-information storage unit 540. Thus, the key server 53 judges whether the key-ring requested in the request message has validity. In the case where the result of the judging process is in the affirmative, the process proceeds to step S140. On the contrary, in the case where the result of the judging process is in the negative, the process proceeds to step S144.

The validity information contained in the Torrent File is not limited to the examples described above. Another arrangement is acceptable in which the validity information is information that indicates an expiration time of the Torrent File. More specifically, the expiration time of the Torrent File is a time until which the leecher 50 is able to request, from the key server 53, the decryption keys used for decrypting the encrypted pieces indicated in the file information contained in the Torrent File. In this situation, by referring to the validity information, the leecher 50 is able to find out if the obtained Torrent File is valid at that point of time. For example, when the leecher 50 transmits a request message to the key server 53, the leecher 50 judges whether the expiration time indicated in the expiration time information contained in the Torrent File that has been used to obtain the encrypted pieces has not yet arrived. In the case where the expiration time has not yet arrived, the leecher 50 puts the version information contained in the Torrent File into the request message and transmits the request message to the key server 53.

Further, yet another arrangement is acceptable in which the leecher 50 refers to the valid information contained in the obtained Torrent File, judges whether the Torrent File itself has validity, and obtains an updated Torrent File according to the result of the judging process. For example, an arrangement is acceptable in which, in the case where the leecher 50 has judged that the obtained Torrent File is not valid or in the case where the leecher 50 has judged that the expiration time of the Torrent File is arriving soon and the period of time before the expiration time arrives is shorter than a predetermined length, the leecher 50 obtains an updated Torrent File from the sales server 54 from which the expiring Torrent File was obtained or from another sales server 54. Yet another arrangement is acceptable in which, when the leecher 50 has started obtaining encrypted pieces by using a Torrent File that was obtained at a certain point in time, and the seeder 52 stores therein an encrypted piece corresponding to an index that is unknown to the leecher 50, the leecher 50 receives the encrypted piece corresponding to the unknown index from the seeder, and after having received the encrypted piece, the leecher 50 obtains an updated Torrent File and checks the completeness or the authenticity of the encrypted piece that has been received.

On the other hand, the Torrent-File validity-information storage unit 540 included in the key server 53 stores therein the pieces of version information of the Torrent Files and the pieces of validity information of the pieces of version information, while keeping them in correspondence with one another. With respect to the version information contained in the request message that has been received from the leecher 50, the validity judging unit 539 refers to one of the pieces of validity information that is stored in the Torrent-File validity-information storage unit 540 in correspondence with the version information and judges whether the expiration time has not yet arrived. In the case where the decryption keys requested in the request message have mutually different pieces of version information, the validity judging unit 539 performs the judging process for each of the decryption keys. In the case where the validity judging unit 539 has judged that the expiration time has not arrived yet for any of the decryption keys, the validity judging unit 539 judges that the key-ring requested in the request message is valid.

Also in this configuration described above, it is possible to inhibit illegitimate use of the content more effectively.

In the first embodiment described above, only the Torrent File having the most updated version information of which the value has been updated by the piece processing apparatus is valid; however, the present invention is not limited to this example. Another arrangement is acceptable in which the Torrent Files having the version information of which the value has been updated by the piece processing apparatus and that is older than the most updated version are valid. Yet another arrangement is acceptable in which the range of version information of the valid Torrent Files is changed as necessary.

In the first embodiment described above, the encrypted pieces and the decryption keys are updated once every predetermined period of time; however, the present invention is not limited to this example. For instance, another arrangement is acceptable in which the encrypted pieces and the decryption keys are updated immediately after the key-ring has been leaked.

At step S140H described above, another arrangement is acceptable in which, in the case where the result of the judging process for at least one of the pieces of version information is in the negative, the key server 53 informs the leecher 50 which one of the decryption key is invalid by transmitting the index information corresponding to such a piece of version information to the leecher 50.

Further, at step S10, the leecher 50 puts the version information into the request message and transmits the request message to the key server 53; however, the present invention is not limited to this example. Another arrangement is acceptable in which the leecher 50 transmits the version information to the key server 53, after having received the acceptance message or at some other time. The same applies to the hash values and the validity information explained in the modification examples of the first embodiment.

In the first embodiment described above, another arrangement is acceptable in which, when the leecher 50 obtains the encrypted pieces from the seeder 52, the leecher 50 judges whether the encrypted pieces stored in the seeder 52 have validity, by using the version information contained in the Torrent File. In this situation, when the seeder 52 transmits the piece information to the leecher 50, the seeder 52 also transmits, to the leecher 50, the version information of the Torrent File that corresponds to the encrypted pieces stored therein. In this situation, like in the example according to the first embodiment in which the leecher 50 transmits the version information to the key server 53, an arrangement is acceptable in which the seeder 52 transmits the piece information and the version information by transmitting a combination of the version information and the index information.

After that, the leecher 50 judges whether the encrypted pieces stored in the seeder 52 have validity by using the version information obtained from the seeder 52.

FIG. 20 is an exemplary functional diagram of the leecher 50 according to the present modification example of the first embodiment. In the present modification example, the content obtaining unit 500 in the leecher 50 includes a validity judging unit 500a. When the piece information and the version information have been received from the seeder 52, the validity judging unit 500a compares the version information with the version information contained in the Torrent File obtained from the tracker 51 and judges whether the encrypted pieces stored in the seeder 52 have validity according to the result of the comparing process. After that, according to the result of the judging process performed by the validity judging unit 500a, the content obtaining unit 500 obtains the encrypted pieces from the seeder 52.

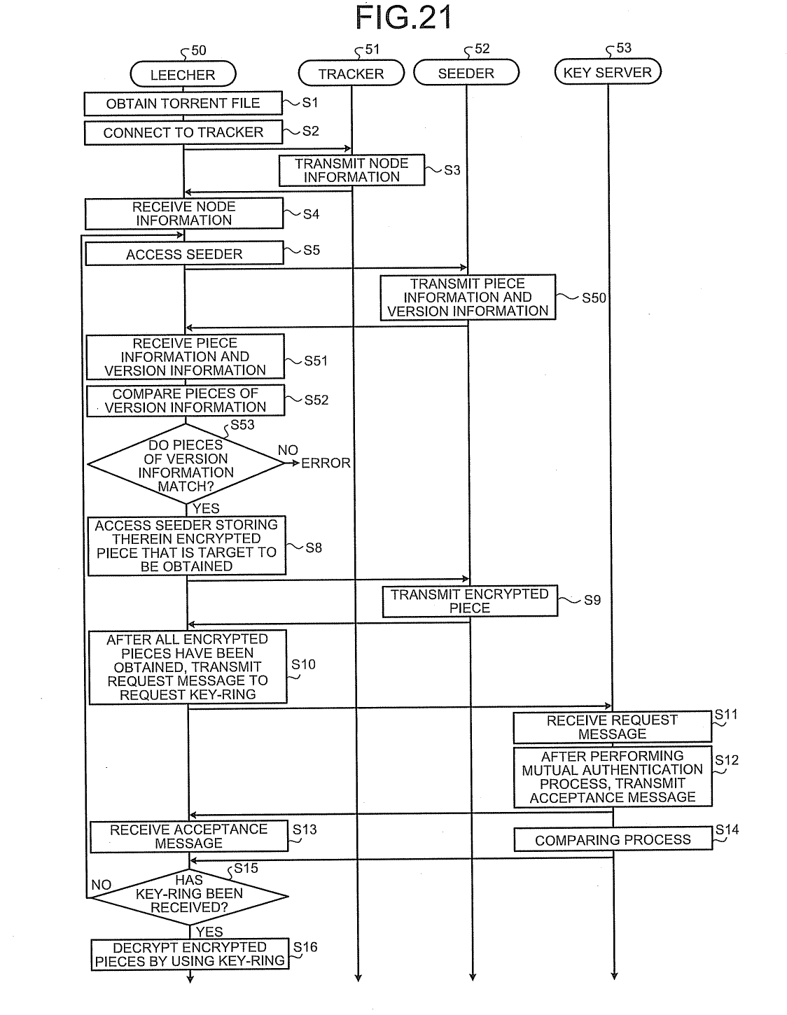

Next, a procedure in a content distributing process performed in the content distribution system according to the present modification example will be explained, with reference to FIG. 21. The processes performed at steps S1 through S5 are the same as those according to the first embodiment described above. At step S50, the seeder 52 transmits, to the leecher 50, the piece information of the encrypted pieces stored therein and the version information of the Torrent File that has been used to obtain the encrypted pieces. At step S51, the leecher 50 receives the piece information and the version information from the seeder 52. Subsequently, the leecher 50 compares the version information received at step S50 with the version information contained in the Torrent File that has been obtained from the tracker 51 at step S1 and is used to obtain the encrypted pieces (step S52) and judges whether they match. Accordingly, the leecher 50 judges whether the encrypted pieces stored in the seeder 52 have validity (step S53). There is a possibility that the leecher 50 may have performed the process at step S1 a plurality of times and may have obtained a plurality of mutually different Torrent Files from the tracker 51 so that the leecher 50 obtains the encrypted pieces by using the plurality of Torrent Files. In this situation, the leecher 50 compares the version information that has been received at step S50 with each of the pieces of version information that are respectively contained in the plurality of Torrent Files. Also, with regard to the version information obtained from the seeder 52, there is a possibility that the version information may be different for each of the encrypted pieces. In this situation, the leecher 50 performs the comparing process of the version information for each of the encrypted pieces. At step S52, in the case where, for each of the encrypted pieces, the obtained version information matches the version information contained in the Torrent File used by the leecher 50 to obtain the encrypted piece, the leecher 50 judges that the encrypted pieces stored in the seeder 52 are valid and performs the processes at step S8 and thereafter in the same manner as in the first embodiment. At step S14, it is sufficient if the key server 53 performs the processes at step S140 and thereafter without performing the processes at steps S140H and S140G shown in FIG. 16. On the contrary, at step S52, in the case where the obtained version information does not match the version information contained in the Torrent File for any of the encrypted pieces, the leecher 50 judges that the encrypted pieces stored in the seeder 52 are not valid and does not obtain the encrypted pieces from the seeder 52. In this situation, an arrangement is acceptable in which the process returns to step S1 or step S5 so that the leecher 50 performs the processes all over again.

As explained above, the leecher 50 obtains only the encrypted pieces that are judged to be valid by the leecher 50 itself, by using the version information contained in the one or more Torrent Files. With this arrangement, even if the decryption keys used for decrypting the encrypted pieces have been disclosed, it is possible to prevent the encrypted pieces from being obtained. Thus, it is possible to more effectively inhibit illegitimate use of the content that is harmfully caused by illegitimate actions.

In the case where the pieces of version information of the Torrent Files corresponding to the encrypted pieces stored in the seeder 52 are all the same, another arrangement is acceptable in which the seeder 52 transmits the version information to the leecher 50 at a time that is different from the time at which the piece information is transmitted. For example, it is acceptable if the seeder 52 transmits the version information to the leecher 50 when the seeder 52 negotiates a connection between the seeder 52 and the leecher 50. As another example of a method used by the seeder 52 to obtain the version information, it is acceptable if the seeder 52 transmits a hash value that is calculated through a hash calculation process by using a Torrent File, and when the leecher 50 has received the hash value, the leecher 50 searches for a Torrent File with which the same hash value can be calculated and obtains the version information contained in the Torrent File found in the search.

In the first embodiment described above, the node information indicates the IP addresses and the port numbers of the nodes; however, the present invention is not limited to this example. Another arrangement is acceptable in which the node information indicates only the IP addresses or the node information indicates the MAC addresses of the nodes. Yet another arrangement is acceptable in which the node information indicates subscribers' IDs that are assigned to the subscribers when they subscribe to the content distribution service. Yet another arrangement is acceptable in which the node information contains the URLs of the nodes or contains the URLs of the nodes in addition to the sets each made up of the IP address and the port number of a different one of the nodes. In this situation, it is sufficient if each of the nodes transmits, to the tracker 51, at least one of the IP address of the node, the MAC address of the node, the subscriber's ID, and the URL, as the node identification information.

Further, in the first embodiment described above, when the tracker 51 generates the node information, each of the nodes transmits the node identification information to the tracker 51; however, the present invention is not limited to this example. Another arrangement is acceptable in which each of the nodes transmits Torrent File identification information to the tracker 51, in addition to the node identification information. The Torrent File identification information is information that uniquely identifies a Torrent File and may be, for example, a hash value of a part or all of the Torrent File or the file name of the Torrent File. Alternatively, another arrangement is acceptable in which the Torrent File is configured so as to have a field showing the ID thereof, so that the value of the shown ID is treated as the Torrent File identification information. In this situation, an arrangement is acceptable in which the tracker 51 generates node information for each of pieces of Torrent File identification information. In this situation, when being accessed by the leecher 50, the tracker 51 transmits, to the leecher 50, the node information corresponding to the piece of Torrent File identification information transmitted by the leecher 50.

Yet another arrangement is acceptable in which the tracker 51 divides the nodes into groups based on the node identification information thereof and generates node information for each of the groups. In this situation, when being accessed by the leecher 50, the tracker 51 transmits, to the leecher 50, the node information corresponding to the group to which the node identification information of the leecher 50 belongs. In this arrangement, it is acceptable for the tracker 51 to divide the nodes into groups in such a manner that the leecher 50 belongs to two or more of the groups. In this situation, the tracker 51 transmits, to the leecher 50, node information corresponding to all or a part of the groups to which the node identification information of the leecher 50 belongs.

Further, another arrangement is acceptable in which, when generating the node information, the tracker 51 divides the nodes into groups by using the version information contained in the Torrent Files. For example, the tracker 51 generates the node information so that the connection destinations of the nodes respectively storing therein Torrent Files that contain mutually the same version information are indicated in one piece of node information. Further, yet another arrangement is acceptable in which the tracker 51 generates the node information so that the connection destinations of the nodes respectively storing therein Torrent Files that contain version information showing one of version numbers that are not mutually the same but are within a predetermined range (e.g., only Version 1 and Version 2) are indicated in one piece of node information. When the leecher 50 accesses the tracker 51 and obtains the node information, the leecher 50 transmits the version information of the Torrent File to the tracker 51. The tracker 51 then transmits, to the leecher 50, the node information corresponding to the version information transmitted from the leecher 50. With this arrangement, all the nodes whose connection destination is indicated in the node information transmit and receive the encrypted pieces by using the Torrent Files containing the version information showing mutually the same version numbers or the version numbers in the predetermined range. In this situation it means that, as long as the Torrent File is valid, the node indicated as the connection destination has stored therein valid encrypted pieces. In other words, there is no possibility that invalid encrypted pieces are downloaded from the node indicated as the connection destination. Thus, with this arrangement, it is possible to distribute the encrypted pieces more efficiently. As other examples, it is acceptable if the tracker 51 divides the nodes into groups, instead of by using the version information, by using the various types of version management information explained in one of the modification examples of the first embodiment or by using the Torrent File identification information explained in another one of the modification examples of the first embodiment.

In the first embodiment described above, another arrangement is acceptable in which the Torrent Files transmitted from the sales server 54 to the leechers 50 are different for each of the groups to which the leechers 50 belong. In other words, mutually different Torrent Files that contain file information indicating mutually different sets of encrypted pieces are respectively transmitted to mutually different groups of the leechers 50. As a result, the set of encrypted pieces distributed in the P2P network NT is different for each of the groups. For example, to the leecher 50 that belongs to a first group, a Torrent File that contains file information indicating that there are encrypted pieces expressed as {E(K(i,1)) [C1], E(K(i,2)) [C2], . . . , E(K(i,N)) [CN]} (where 1=i=2 is satisfied) is transmitted. On the other hand, to another leecher 50 that belongs to a second group, a Torrent File that contains file information indicating that there are encrypted pieces expressed as {E(K(i,1)) [C1], E(K(i,2)) [C2], . . . , E(K(i,N)) [CN]} (where 3=i=5 is satisfied) is transmitted.

It is acceptable to divide the nodes into groups based on the regions in which the sales server 54 is offering the content distribution service. For example, an arrangement is acceptable in which the Torrent File that is transmitted to the leecher 50 by the sales server 54 offering a distribution service for users in Japan is different from the Torrent File that is transmitted to the leecher 50 from the sales server 54 offering a distribution service for users in the USA.

In this situation, as explained in one of the modification examples of the first embodiment, it is acceptable to divide the Torrent Files into groups according to how the pieces of node information are divided into groups by the tracker 51. For example, an arrangement is acceptable in which the tracker 51 divides the nodes into groups in such a manner that each of the nodes belongs to at least one group and that the transmitted Torrent File is different for each of the groups, so that the tracker 51 transmits, to each of the nodes, node information indicating the other nodes belonging to the same group as the recipient node. Also, in this situation, the groups for the node information and the groups for the Torrent Files may be in one-to-one correspondence or may be in multiple-to-one correspondence.

As explained above, with this arrangement in which the leechers 50 are divided into the groups and the Torrent Files are transmitted, even if a key-ring used for decrypting the encrypted pieces distributed to a group that is different from the group to which the leecher 50 belongs has been disclosed, the leecher 50 is not able to decrypt, with the disclosed key-ring, the encrypted pieces that the leecher 50 has obtained by using a Torrent File. Thus, it is less likely that the illegitimate action of disclosing the key-ring will be taken. Also, it is possible to further limit the range of the impact caused by the illegitimate actions. In the first embodiment describe above, when a Torrent File has been updated and the tracker connection destination information contained in the Torrent File has been changed, it is acceptable to halt a function of the tracker 51 to which a connection can be established by using the tracker connection destination information contained in the Torrent File that is pre-update and should be invalidated. In other words, an arrangement is acceptable in which the tracker 51 halts its function of transmitting the node information to the leecher 50 that has accessed the tracker 51. In this situation, for example, an external apparatus transmits, to the tracker 51, a halt request message to request that the function of the tracker 51 should be halted. In the present example, the external apparatus may be, for example, the sales server 54, the seeder 52, the leecher 50, a content provider, or a piece processing apparatus. When having received the halt request message, even if the leecher 50 has accessed the tracker 51 by using the tracker connection destination information contained in the Torrent File to be invalidated, the tracker 51 does not transmit the node information to the leecher 50.

Yet another arrangement is acceptable in which the tracker 51 does not transmit the node information to some of the leechers 50 that have accessed the tracker 51 by using the tracker connection destination information contained in the Torrent File to be invalidated, instead of not transmitting the node information to any of the leechers 50 that have accessed the tracker 51. For example, when a Torrent File has been updated and the tracker connection destination information contained in the Torrent File has been changed, an arrangement is acceptable in which the tracker 51 obtains, from an external apparatus, a list indicating pieces of leecher identification information for identifying the leechers 50 to which the node information should not be transmitted, in addition to the halt request message. Each of the pieces of leecher identification information may be, for example, the IP address of the leecher 50, the port number of the leecher 50, the MAC address of the leecher 50, or the subscriber's ID explained above, or a combination of any of these. In this configuration, the tracker 51 obtains the leecher identification information from the leecher 50 that has accessed the tracker 51 and judges whether the obtained leecher identification information is shown in the list. In the case where the result of the judging process is in the affirmative, the tracker 51 does not transmit the node information to the leecher 50.

With these arrangements, it is possible to more effectively inhibit obtainment of encrypted pieces that uses the Torrent Files to be invalidated. Consequently, it is possible to more effectively inhibit illegitimate use of the content.

Yet another arrangement is acceptable in which, when a Torrent File has been updated, the tracker 51 to which a connection can be established by using the tracker connection destination information contained in the Torrent File that is pre-update and should be invalidated transmits a prompt message to the leecher 50 that has accessed the tracker 51 to prompt the leecher 50 to obtain the updated Torrent File. In this situation, the leecher 50 obtains the updated Torrent File from the sales server 54, according to the prompt message. As a result, the leecher 50 is able to obtain the encrypted pieces by using the updated Torrent File. Thus, it is possible to prompt the leecher 50 to obtain the newer encrypted pieces.

Next, a second embodiment of the content distribution system will be explained. Parts of the second embodiment that are the same as the first embodiment will be explained by using the same reference characters or will be omitted from the explanation. A configuration according to the second embodiment will be explained while a focus is placed on the differences from the basic configuration of the content distribution system explained in the description of the first embodiment. According to the second embodiment, each Torrent File does not necessarily have to contain the version information, which is used for realizing the function with which the first embodiment is characterized. Accordingly, the key server 53 does not necessarily have to include the validity judging unit 539 and the Torrent-File validity-information storage unit 540. According to the second embodiment, the key server 53 checks to see if the leecher 50 has actually stored therein the encrypted pieces that are to be decrypted by using the decryption keys contained in the key-ring requested by the leecher 50.

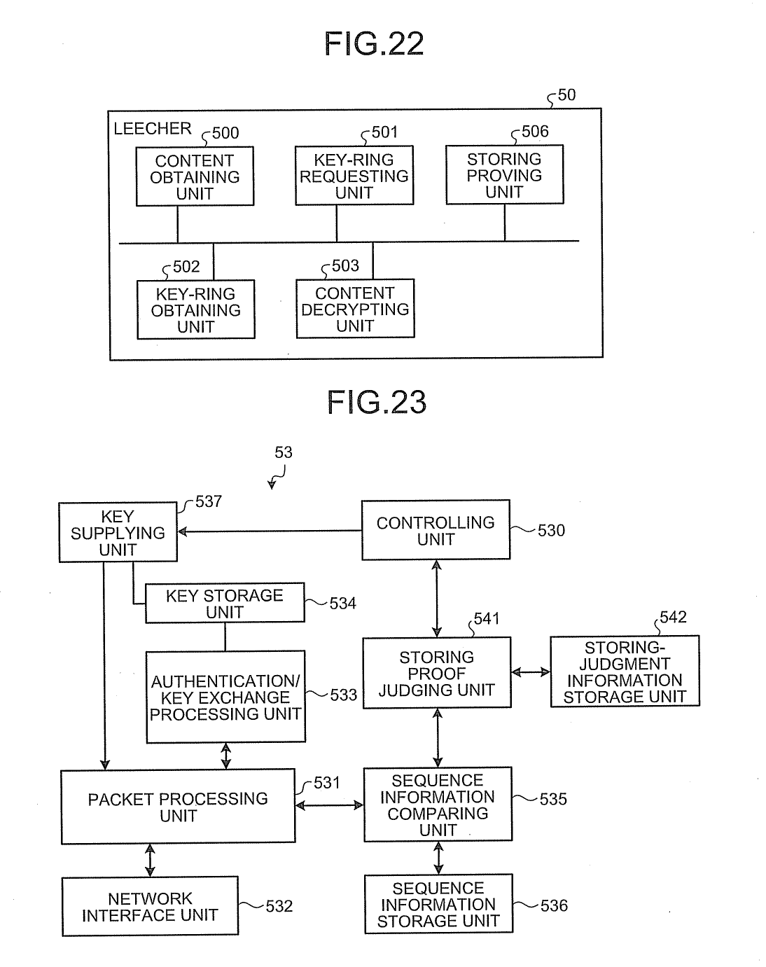

According to the second embodiment, after the leecher 50 has transmitted the request message to the key server 53 to request the key-ring containing the decryption keys used for decrypting the encrypted pieces, the leecher 50 transmits, to the key server 53, a hash value that is calculated through a hash calculation process by using at least two of the encrypted pieces, in response to a request from the key server 53. FIG. 22 is an exemplary functional diagram of the leecher 50 according to the second embodiment. According to the second embodiment, the leecher 50 includes a storing proving unit 506, in addition to the content obtaining unit 500, the key-ring requesting unit 501, the key-ring obtaining unit 502, and the content decrypting unit 503.

The storing proving unit 506 transmits, to the key server 53, storing proof information for proving that the leecher 50 has actually stored therein the encrypted pieces to be decrypted by using the decryption keys contained in the key-ring requested in the request message that has been transmitted from the key-ring requesting unit 501 to the key server 53. More specifically, the storing proving unit 506 receives, from the key server 53, an information request message for requesting, as the storing proof information, a hash value of at least two of the encrypted pieces to be decrypted by using the decryption keys contained in the key-ring that has been requested in the request message. After that, in response to the information request message, the storing proving unit 506 reads the corresponding encrypted pieces from an external storage device and calculates the hash value through a hash calculation process by using the data obtained by joining the read encrypted pieces together. Subsequently, the storing proving unit 506 transmits the calculated hash value to the key server 53.

FIG. 23 is an exemplary functional diagram of the key server 53 according to the second embodiment. The key server 53 includes a storing proof judging unit 541 and a storing-judgment information storage unit 542, in addition to the controlling unit 530, the packet processing unit 531, the network interface unit 532, the authentication/key exchange processing unit 533, the key storage unit 534, the sequence information storage unit 536, the sequence information comparing unit 535, and the key supplying unit 537. The storing-judgment information storage unit 542 stores therein storing judgment information used for judging whether the leecher 50 has actually stored therein the encrypted pieces to be decrypted by using the decryption keys contained in the key-ring that has been requested in the request message received by the authentication/key exchange processing unit 533 from the leecher 50. More specifically, the storing-judgment information storage unit 542 stores therein, as the storing judgment information, all the encrypted pieces in correspondence with the indexes, like the initial seeder 52A.

By using the storing judgment information stored in the storing-judgment information storage unit 542, the storing proof judging unit 541 judges whether the leecher 50 has actually stored therein the encrypted pieces to be decrypted by using the decryption keys contained in the key-ring that has been requested in the request message received by the authentication/key exchange processing unit 533 from the leecher 50. More specifically, the storing proof judging unit 541 selects the two or more of the encrypted pieces of which the hash value is to be requested, by using the index information contained in the request message. After that, the storing proof judging unit 541 transmits the information request message to the leecher 50 to request the hash value of the selected encrypted pieces. For example, in the case where the sequence indicated in the index information is {(i1,1), (i2,2), . . . , (iN,N)}, the storing proof judging unit 541 arbitrarily selects two or more of the indexes contained in the sequence. Subsequently, the storing proof judging unit 541 transmits, to the leecher 50, the information request message that indicates the selected indexes and requests the hash value of the encrypted pieces corresponding to the selected indexes. Also, the storing proof judging unit 541 reads the selected encrypted pieces from the storing-judgment information storage unit 542 and calculates a hash value through a hash calculation process by using the read encrypted pieces. After that, when the leecher 50 has transmitted a hash value in response to the information request message, the storing proof judging unit 541 receives the transmitted hash value and compares the received hash value with the calculated hash value. Subsequently, according to the result of the comparing process, the storing proof judging unit 541 judges whether the leecher 50 has actually stored therein the encrypted pieces to be decrypted by using the decryption keys contained in the key-ring that has been requested in the request message received from the leecher 50. The sequence information comparing unit 535 performs the comparing process on the sequence information according to the result of the judging process performed by the storing proof judging unit 541.

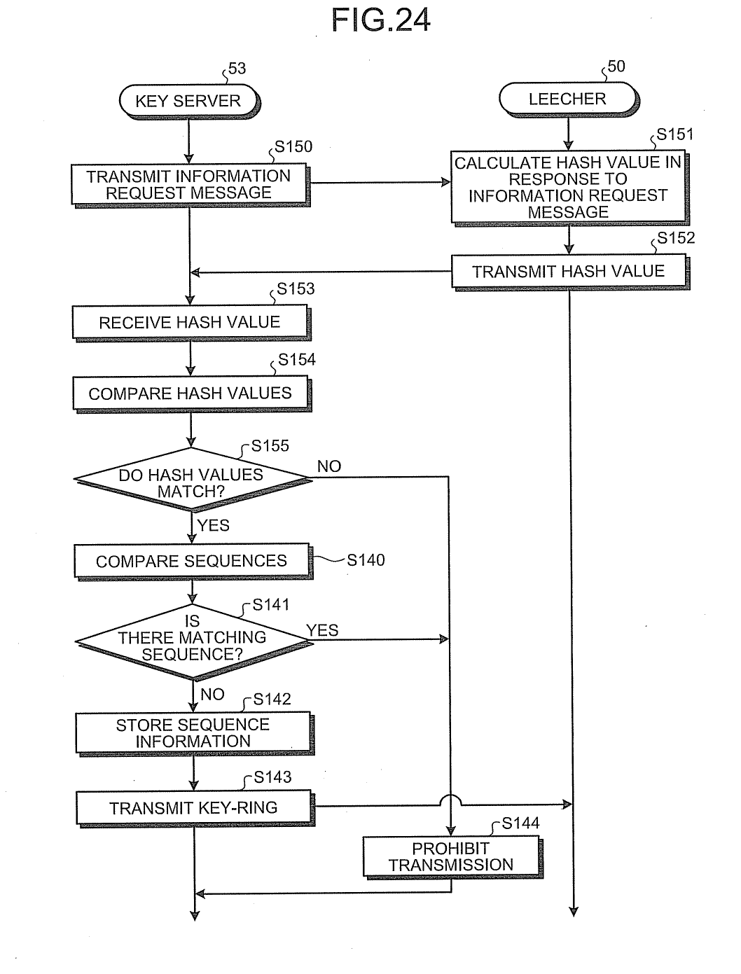

Next, a procedure in a content distributing process performed in the content distribution system according to the second embodiment will be explained, with reference to FIG. 12. The processes performed at steps S1 through S13 are the same as those according to the basic configuration described above. At step S14, the key server 53 performs a comparing process as described below. FIG. 24 is a flowchart of a procedure in the comparing process according to the second embodiment. For example, let us assume that the index information contained in the request message that has been received by the key server 53 at step S11 is as shown below:
{(i1,1), (i2,2), . . . , iN,N)}
where 1=i1, . . . , iN=m is satisfied.

The storing proof judging unit 541 included in the key server 53 arbitrarily selects two or more of the indexes contained in the sequence indicated in the index information. After that, the storing proof judging unit 541 transmits, to the leecher 50, an information request message that indicates the selected indexes and requests a hash value of the encrypted pieces corresponding to the selected indexes (step S150). For example, the storing proof judging unit 541 transmits, to the leecher 50, an information request message for requesting a hash value of the two encrypted pieces identified with the indexes (i2,2) and (i4,4).

On the other hand, when having received the information request message, the leecher 50 reads the corresponding encrypted pieces from an external storage device, calculates a hash value through a hash calculation process by using the data obtained by joining the read encrypted pieces together (step S151) and transmits the calculated hash value to the key server 53 (step S152). For example, the leecher 50 joins together the two encrypted pieces identified with the indexes (i2,2) and (i4,4) and calculates a hash value shown below through a hash calculation process by using the joined data:
hash(E(K(i2,2)) [C2]∥E(K(i4,4)) [C4])
In this expression “∥” denotes the joining of the data.

The key server 53 reads the selected encrypted pieces out of the storing-judgment information storage unit 542 and calculates a hash value through a hash calculation process by using the read encrypted pieces. Subsequently, when the key server 53 has received the hash value transmitted from the leecher 50 (step S153), the key server 53 compares the received hash value with the calculated hash value (step S154). In the case where the received hash value and the calculated hash value match (step S155: Yes), the key server 53 judges that the leecher 50 has actually stored therein the encrypted pieces to be decrypted by using the decryption keys contained in the key-ring that has been requested in the request message received at step S11 and performs the processes at step S141 and thereafter. On the contrary, in the case where the received hash value and the calculated hash value do not match at step S155 (step S155: No), the key server 53 judges that the leecher 50 does not actually store therein the encrypted pieces to be decrypted by using the decryption keys contained in the key-ring that has been requested in the request message received at step S11, and the process proceeds to step S144. In other words, in this situation, the key server 53 does not follow the request message received at step S11 and does not transmit the key-ring to the leecher 50.

In the manner explained above, the key server 53 checks to see if the leecher 50 has actually stored therein the encrypted pieces to be decrypted by using the decryption keys contained in the key-ring, before transmitting the key-ring requested by the leecher 50. Subsequently, in the case where the key server 53 has confirmed that the leecher 50 does not actually store therein the encrypted pieces, the key server 53 does not transmit the key-ring to the leecher 50. With this arrangement, for example, it is possible to eliminate the illegitimate action where the leecher 50 requests the key-ring from the key server 53 without downloading the encrypted pieces for the purpose of leaking the key-ring.

In the second embodiment described above, the storing-judgment information storage unit 542 stores therein all the encrypted pieces as the storing judgment information. However, because this arrangement requires a large storage capacity, another arrangement is acceptable in which the storing-judgment information storage unit 542 stores therein only a part of the encrypted pieces. In other words, for example, as the encrypted pieces of which the quantity is equal to m with respect to each of the pieces C1 to C3, it is acceptable if the storing-judgment information storage unit 542 stores therein only the encrypted pieces as shown below, of which the total quantity is equal to 3m:
E(K(1,1)) [C1], . . . , E(K(m,1)) [C1], E(K(1,2)) [C2], . . . , E(K(m,2)) [C2], and E(K(1,3)) [C3], . . . , E(K(m,3)) [C3]
Subsequently, from the range of the encrypted pieces stored in the storing-judgment information storage unit 542, the storing proof judging unit 541 selects two or more of the indexes (i1,1), (i2,2), (i3,3) contained in the sequence indicated in the index information contained in the request message and requests a hash value of the encrypted pieces corresponding to the indexes from the leecher 50. With this arrangement, it is possible to reduce the storage capacity required in the storing-judgment information storage unit 542.

Another arrangement is acceptable in which, at step S150, the storing proof judging unit 541 selects encrypted pieces that are not stored in the storing-judgment information storage unit 542. In this situation, the storing-judgment information storage unit 542 obtains the selected encrypted pieces from another communication apparatus such as the seeder 52 or another leecher 50.

Yet another arrangement is acceptable in which the storing-judgment information storage unit 542 stores therein, as the storing judgment information, hash values of the encrypted pieces, instead of the encrypted pieces themselves. In this situation, the storing-judgment information storage unit 542 may store therein the hash values of all the combinations made from at least two of the encrypted pieces or may store therein only the hash values that are to be requested from the leecher 50 or that have a possibility of being requested from the leecher 50. In this situation, at step S154, the storing proof judging unit 541 compares the hash value received from the leecher 50 at step S153 with the hash value that is stored in the storing-judgment information storage unit 542 and can be calculated by using the two or more encrypted pieces selected at step S150.

Also, in this situation, another arrangement is acceptable in which, at step S150, the storing proof judging unit 541 selects encrypted pieces with which a hash value that is not stored in the storing-judgment information storage unit 542 is calculated. In this situation, the storing-judgment information storage unit 542 obtains the hash value itself or the encrypted pieces with which the hash value can be calculated, from another communication apparatus such as the seeder 52 or another leecher 50.

In the second embodiment described above, the leecher 50 calculates the hash value and transmits the calculated hash value as the storing proof information to the key server 53, in response to the request from the key server 53; however, the present invention is not limited to this example. Another arrangement is acceptable in which the leecher 50 transmits, to the key server 53, all or a part of the data obtained by joining two or more of the encrypted pieces together, as the storing proof information. In this situation, at step S150, after the storing proof judging unit 541 included in the key server 53 has selected the two or more of the encrypted pieces by using the index information contained in the request message, the storing proof judging unit 541 transmits, to the leecher 50, an information request message that indicates the indexes of the selected encrypted pieces and that requests the data obtained by joining the selected encrypted pieces together. Let us assume, for example, that the information request message requests the data obtained by joining together the encrypted piece corresponding to the index (i2,2) and the encrypted piece corresponding to the index (i4,4). In this situation, at step S151, when having received the information request message, the leecher 50 joins together the encrypted piece corresponding to the index (i2,2) and the encrypted piece corresponding to the index (i4,4) and generates data (E(K(i2,2)) [C2]∥E(K(i4,4)) [C4]). At step S152, the leecher 50 transmits the generated data to the key server 53. The storing proof judging unit 541 included in the key server 53 generates data obtained by joining together the encrypted pieces that are stored in the storing-judgment information storage unit 542 and that have been selected at step S150. After that, when the storing proof judging unit 541 has received the generated data at step S153, the storing proof judging unit 541 compares the received data with the data generated by itself at step S154. In the case where these pieces of data match, the storing proof judging unit 541 performs the processes at step S140 and thereafter.

In the second embodiment described above, the number of encrypted pieces selected by the key server 53 at step S150 may be a fixed value that is two or larger or may be a variable value that is two or larger and is changed as necessary.

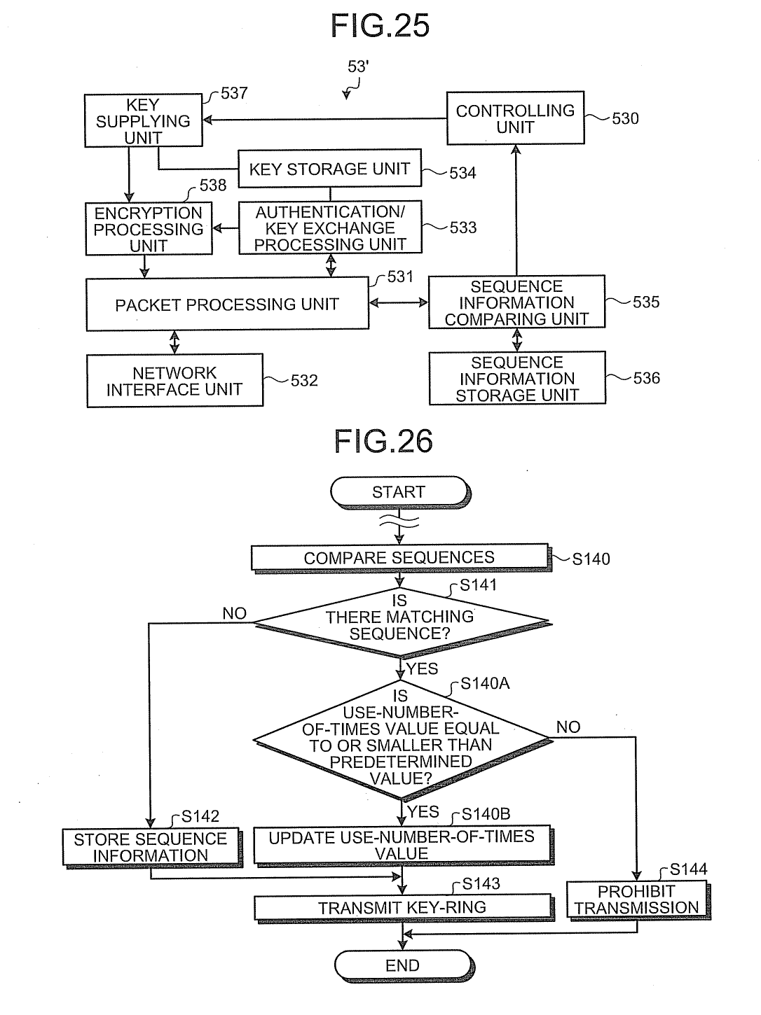

In the first and the second embodiments described above, another arrangement is acceptable in which the key server 53 and the leecher 50 encrypt the data that is the target of the communication, after having performed the mutual authentication process. FIG. 25 is an exemplary diagram of a key server that is configured in this manner. The key server 53′ includes an encryption processing unit 538, in addition to the controlling unit 530, the packet processing unit 531, the network interface unit 532, the authentication/key exchange processing unit 533, the key storage unit 534, the sequence information storage unit 536, the sequence information comparing unit 535, and the key supplying unit 537 that are described above. The authentication/key exchange processing unit 533 performs the process to exchange an encryption key used for encrypting the data that is the target of the communication, with the leecher 50. The encryption processing unit 538 encrypts the data that is the target of the communication by using the encryption key exchanged by the authentication/key exchange processing unit 533 and transmits the encrypted data to the leecher 50 via the network interface unit 532.

In the first and the second embodiments described above, an arrangement is acceptable in which the key server 53 itself issues and generates one or both of the encryption keys and the decryption keys. Yet another arrangement is acceptable in which the key server 53 obtains keys that have been issued or generated by the tracker 51 or a server provided by the content creator.

In the description above, each of all the pieces C1 to CN into which the content C has been divided is encrypted with a different one of the encryption keys; however, the present invention is not limited to this example. Another arrangement is acceptable in which two or more of the pieces are encrypted with mutually the same encryption key.

In the first and the second embodiments above, the number of trackers 51, the number of seeders 52, and the number of leechers 50 are not limited to the examples above.

In the description above, the sales server 54 is connected to the P2P network NT so that the leecher 50 obtains the Torrent File from the sales server 54; however, the sales server 54 does not necessarily have to be connected to the P2P network NT. Another arrangement is acceptable in which the leecher 50 obtains the Torrent File by, for example, reading the Torrent File recorded on a recording medium such as a CD-ROM.

Further, in the description above, the leecher 50 is connected to the key server 53 via the network; however, another arrangement is acceptable in which the leecher 50 is connected to the key server 53 via a dedicated line or via a proxy server, instead of via the network. With this arrangement, it is possible to enhance the management capability and to protect the key server, which is positioned at a stage subsequent to the proxy server, from a direct attack.

In the description above, the leecher 50 puts the index information into the request message and transmits the request message to the key server 53 at step S10; however, the present invention is not limited to this example. Another arrangement is acceptable in which the leecher 50 transmits the index information to the key server 53 after having received the acceptance message.

At step S50 described above, the seeder 52 transmits the piece information indicating the sequence of the pieces stored therein and the version information, when the leecher 50 has accessed the seeder 52; however, another arrangement is acceptable in which the seeder 52 transmits the piece information and the version information to the leecher 50, without waiting for the access from the leecher 50.

At step S9 described above, the seeder 52 transmits the encrypted piece to the leecher 50. In addition, it is also acceptable for the seeder 52 to transmit the corresponding index to the leecher 50. For example, an arrangement is acceptable in which, if the transmitted encrypted piece is E(K(1,1)) [C1], the seeder 52 transmits the corresponding index (1,1) to the leecher 50, in addition to the encrypted piece.

In the description above, the leecher 50 receives the encrypted pieces from the seeder 52; however, the present invention is not limited to this example. Another arrangement is acceptable in which the leecher 50 obtains the encrypted pieces from any of the other leechers 50.

Yet another arrangement is acceptable in which, with respect to each of the encrypted pieces that respectively correspond to the pieces C1 to CN, the leecher 50 obtains a plurality of mutually different encrypted pieces for the piece. For example, with respect to the piece C1, it is acceptable for the leecher 50 to obtain the encrypted pieces E(K(i1,1)) [C1] and E(K(i1′,1)) [C1] (where i1≠i1′, 1=i1=m, and 1=i1′=m are satisfied). With this arrangement, when the leecher 50 requests the key-ring from the key server 53, if the sequence containing the index (i1,1) has already been used, the leecher 50 is not able to obtain the key-ring corresponding to the sequence, but if the sequence containing the index (i1′,1) is usable, the leecher 50 is able to obtain the key-ring corresponding to this sequence from the key server 53 without having to access the seeder 52 again. With this arrangement in which the leecher 50 obtains the extra encrypted piece in advance, the leecher 50 is able to prepare the plurality of sequence candidates in advance. Thus, the leecher 50 is able to avoid the trouble of having to access the seeder 52 again.

In the first and the second embodiments described above, in the case where the sequence information storage unit 536 already stores therein the sequence that corresponds to the key-ring being requested by the leecher 50, the sequence information comparing unit 535 included in the key server 53 instructs, via the controlling unit 530, the key supplying unit 537 that the transmission of the key-ring to the leecher 50 is prohibited, at step S144; however, the present invention is not limited to this example. Another arrangement is acceptable in which, for example, in the case where the leecher 50 has obtained the encrypted contents E(K(i1,1)) [C1], E(K(i2,2)) [C2], . . . , E(K(iN,N)) [CN] and requests the corresponding key-ring from the key server 53, if the sequence information storage unit 536 has already stored therein the sequence {(i1,1), (i2,2), . . . , (iN,N)} that corresponds to the key-ring requested by the leecher 50, the key server 53 generates another sequence {(i1′,1), (i2,2), . . . , (iN,N)} that is not stored in the sequence information storage unit 536 and transmits, to the leecher 50, the encrypted piece E(K(i1′,1)) [C1] with which the leecher 50 should replace the other encrypted piece and information related to the index thereof (i.e., (i1′,1) in the present example). In addition, the key server 53 transmits a key-ring containing the decryption keys that respectively correspond to the another sequence {(i1′,1), (i2,2) , . . . , (iN,N)} to the leecher 50. With this arrangement, the leecher 50 is able to avoid the trouble of having to access the tracker 51 again for the purpose of obtaining the encrypted pieces that correspond to the sequence for which the transmission of the key-ring is permitted in the comparing process performed by the sequence information comparing unit 535 included in the key server 53. In this situation, the key server 53 needs to store therein, in advance, the encrypted piece that can be transmitted to the leecher 50. The number of stored encrypted pieces may be one or may be more than one. In the case where the key server 53 stores therein more than one encrypted piece, it is acceptable for the key server 53 to transmit, to the leecher 50, the plurality of encrypted pieces each as the encrypted piece with which the leecher 50 should replace the other encrypted piece (together with the information related to the indexes thereof). In the case where the sequence information storage unit 536 has not yet stored therein the sequence {(i1,1), (i2,2), . . . , (iN,N)} that corresponds to the key-ring requested by the leecher 50, the key server 53 may or may not perform the replacement process described above.

According to the first and the second embodiments described above, during the comparing process, the sequence information comparing unit 535 instructs that the key-ring should not be transmitted if the key-ring requested by the leecher 50 was transmitted in the past at least once to any of the leechers 50; however, the present invention is not limited to this example. Another arrangement is acceptable in which the key server 53 is allowed to transmit one key-ring up to a predetermined number of times such as twice or more. In this situation, the authentication/key exchange processing unit 533 included in the key server 53 obtains, from the leecher 50, leecher identification information for identifying the leecher 50, during the mutual authentication process performed with the leecher 50. The sequence information comparing unit 535 stores, into the sequence information storage unit 536, the sequence information that indicates the sequence of the key-ring, the leecher identification information, and a use-number-of-times value that indicates how many times the leecher 50 identified with the leecher identification information has requested a transmission of the key-ring, while keeping these pieces of information in correspondence with one another. FIG. 26 is a flowchart of a procedure in the comparing process according to the present modification example. In FIG. 26, the processes that are performed before step S140 are omitted. The processes at steps S140 through S141 are performed in the same manner as in the first embodiment. In the case where the result of the judging process at step S141 is in the affirmative, that is, in the case where the sequence information storage unit 536 has already stored therein the sequence information indicating the same sequence as the sequence of the key-ring requested by the leecher 50, the sequence information comparing unit 535 refers to the use-number-of-times value that is stored in the sequence information storage unit 536 in correspondence with the sequence information and the leecher identification information of the leecher 50 and judges whether the use-number-of-times value is equal to or smaller than a predetermined value (step S140A). In the case where the result of the judging process is in the affirmative, the sequence information comparing unit 535 updates the use-number-of-times value by incrementing, by one, the use-number-of-times value stored in the sequence information storage unit 536 in correspondence with the sequence information and the leecher identification information (step S140B) and performs the process at step S143 as described above. On the contrary, in the case where the result of the judging process at step S141 is in the negative, the sequence information comparing unit 535 performs the processes at step S142 and thereafter as described above. In the case where the result of the judging process at step S140A is in the negative, the sequence information comparing unit 535 performs the same process as at step S144 described above.

With this arrangement, it is permitted to use the same sequence of encrypted pieces a plurality of times, instead of only once. Thus, it is possible to realize a more flexible content distributing process.

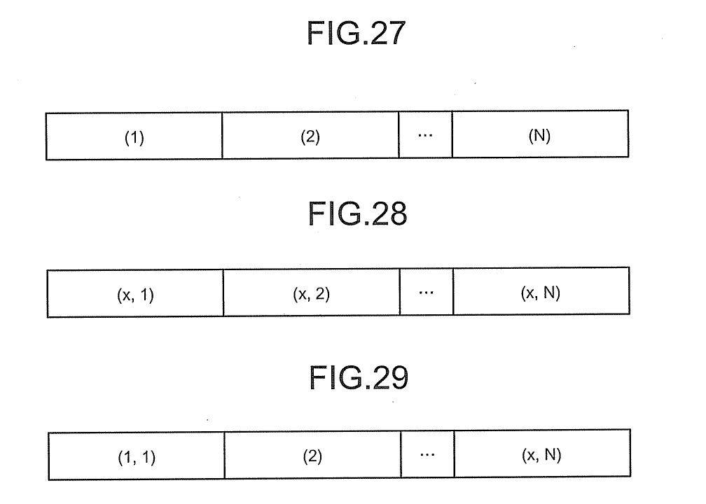

In the first and the second embodiments described above, the piece information transmitted from the seeder 52 to the leecher 50 indicates the sequence of the encrypted pieces stored in the seeder 52, as shown in FIG. 7. However, another arrangement is acceptable in which, of the indexes (i,j) of the encrypted pieces stored in the seeder 52, the piece information indicates only the indexes j used for distinguishing the pieces C1 to CN from one another. FIGS. 27, 28, and 29 are drawings each of which shows an example of piece information according to the present modification example. In this situation, the file information contained in the Torrent File includes hash values {hash(E(K(i,j)) [Cj])} (where 1=i=m and 1=j=N are satisfied) that are calculated through a hash calculation process by using the encrypted pieces, as explained in one of the modification examples of the first embodiment (see FIG. 17). In the following section, each of the indexes j used for distinguishing the pieces C1 to CN from one another will be referred to as a “piece index”. Each of the indexes i that offer variations according to the number of decryption keys will be referred to as a “variation index”. A set (i,j) made up of a piece index and a variation index will be simply referred to as an “index”. With regard to a piece that corresponds to a piece index j, in the case where there are two or more encrypted pieces that are obtained by encrypting the piece with mutually different two or more encryption keys, a set including these encrypted pieces will be referred to as an “encrypted piece string j”, as necessary.

In this configuration, when the content obtaining unit 500 included in the leecher 50 has obtained an encrypted piece from the seeder 52, based on the piece information as described above, the content obtaining unit 500 performs a process to identify the variation index i with respect to the encrypted piece. More specifically, the content obtaining unit 500 calculates a hash value through a hash calculation process by using the encrypted piece, refers to the file information contained in the Torrent File, and identifies the variation index i that corresponds to the piece index j of the encrypted piece, within the index (i,j) that corresponds to the hash value.

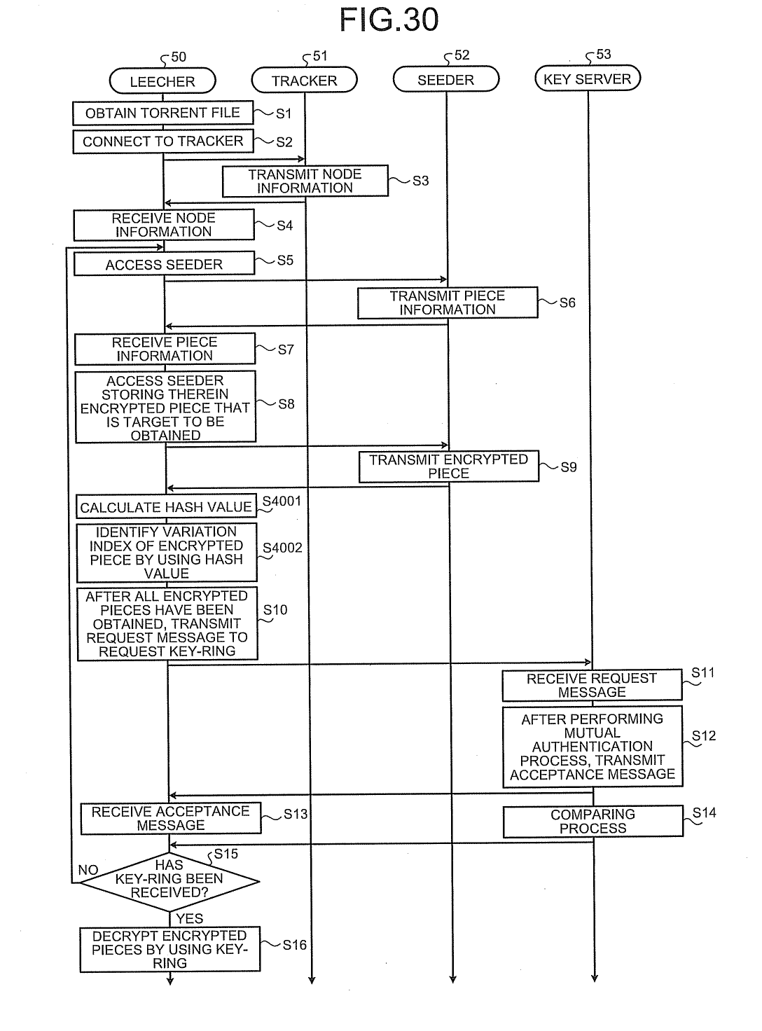

FIG. 30 is a flowchart of a procedure in a content distributing process performed in the content distribution system according to the present modification example. The processes performed at steps S1 through S5 are the same as those according to the first embodiment. At step S6, when being accessed by the leecher 50, the seeder 52 transmits piece information that indicates the piece indexes of the encrypted pieces stored therein to the leecher 50, as shown in FIG. 27, for example. At step S7, the leecher 50 receives the piece information. At step S8, the leecher 50 accesses at least one seeder 52 by using the piece information, transmits a piece request to the seeder 52 to request, for each of the pieces C1 to CN, at least one of the plurality of encrypted pieces that can possibly exist, and receives the encrypted pieces. In response to the piece request from the leecher 50, the seeder 52 transmits the encrypted piece stored therein to the leecher 50 (step S9). In this situation, the indexes indicated in the piece information that the leecher 50 has received by accessing the seeder 52B contains no variation index. Thus, by using the piece information that the leecher 50 has received by accessing the seeder 52B, the leecher 50 judges, for example, whether the seeder 52B stores therein any of the encrypted pieces E(K(i1,1)) [C1] (where i1 is an integer that satisfies 1=i1=m) that are obtained by encrypting the piece C1. In the case where the result of the judging process is in the affirmative, the leecher 50 accesses the seeder 52B and obtains one of the encrypted pieces that are obtained by encrypting the piece C1, by receiving it from the seeder 52B. On the contrary, in the case where the seeder 52B actually does not store therein any of the encrypted pieces obtained by encrypting the piece C1, the leecher 50 further accesses another seeder 52 (e.g., the seeder 52C) and obtains piece information from the another seeder (e.g., the seeder 52C). In the same manner as described above, by using the piece information, the leecher 50 judges whether the seeder 52C stores therein the encrypted piece. In the case where the result of the judging process is in the affirmative, the leecher 50 accesses the seeder 52C and attempts to obtain the encrypted piece.

After that, at step S4001, the leecher 50 calculates a hash value of the received encrypted piece. Subsequently at step S4002, the leecher 50 refers to the Torrent File as shown in FIG. 17 and identifies a variation index i corresponding to the piece index j of the encrypted piece, out of the index (i,j) corresponding to the hash value. The processes performed at step S10 and thereafter are the same as those in the first embodiment or the second embodiment.

In this configuration described above, it is not possible to identify the variation index i of each of the encrypted pieces stored in the seeder 52 before the leecher 50 receives each of the encrypted pieces. Thus, it is possible to more effectively inhibit illegitimate use of the content because it is possible to inhibit the leecher 50 from attempting to obtain the encrypted piece corresponding to a certain index (i,j) for which the decryption key has been leaked.

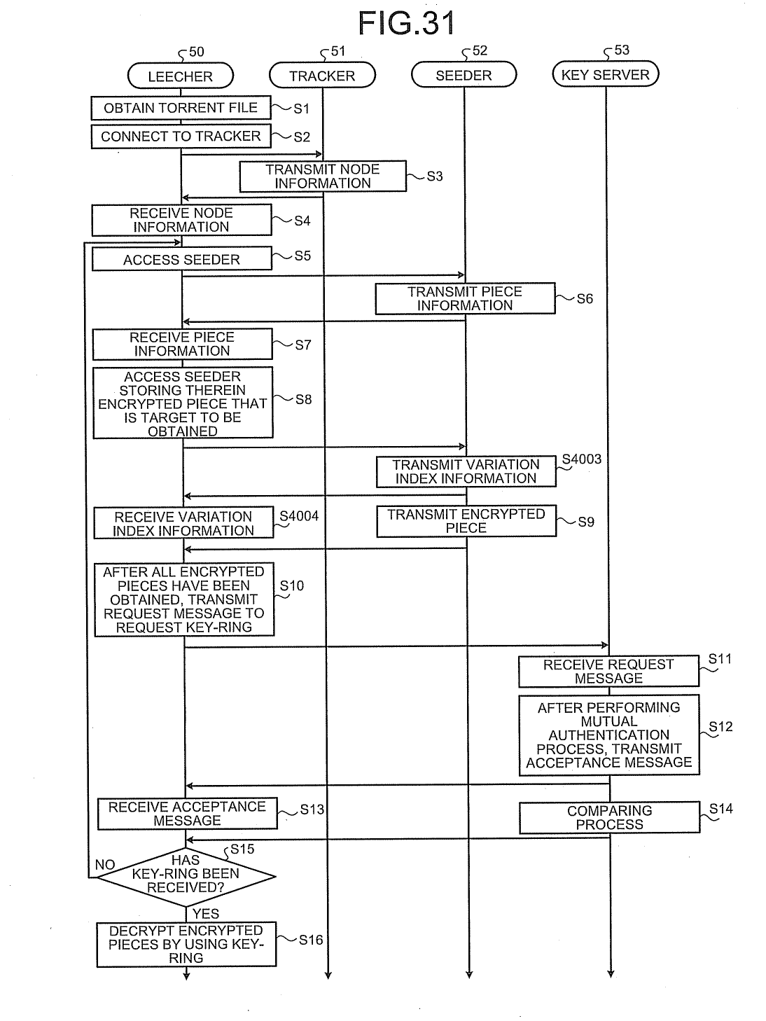

In the modification example described above, another arrangement is acceptable in which, when transmitting the encrypted piece to the leecher 50, the seeder 52 transmits, to the leecher 50, variation index information indicating the variation index of the encrypted piece, separately from the piece information. In that situation, the leecher 50 does not need to calculate the hash value of the encrypted piece, unlike the example described above. Thus, the file information contained in the Torrent File does not need to include the hash value of each of the encrypted pieces. FIG. 31 is a flowchart of a procedure in the content distributing process according to the present modification example. The processes performed at steps S1 through S8 are the same as those according to the modification example described above. At step S4003, the seeder 52 transmits, to the leecher 50, variation index information indicating the variation index of the encrypted piece that is the target to be transmitted to the leecher 50. At step S4004, the leecher 50 receives the variation index information. After that, the processes performed at steps S9 through S16 are the same as those according to the first embodiment or the second embodiment described above. Another arrangement is acceptable in which the processes at steps S4003 through S4004 are performed after the process at step S9 has been performed.

In this configuration described above, it is possible to make it easy for the leecher 50 to identify the variation indexes of the encrypted pieces and also to inhibit the leecher 50 from attempting to obtain the encrypted piece corresponding to, for example, an index (i,j) for which the decryption key has been leaked.

According to the first and the second embodiments, another arrangement is acceptable in which the leecher 50 receives an encrypted piece from the seeder 52 at a plurality of different times. In that situation, with respect to the one encrypted piece, the leecher 50 transmits a piece request (hereinafter, a “partial data request”) to request partial data (hereinafter, a “sub-piece”) that constitutes a part of the encrypted piece, from the seeder 52. The data length of each of the sub-pieces may be a predetermined length or may be a variable length. The number of sub-pieces that constitute each of the encrypted pieces is not limited. Each of the encrypted pieces may be constituted with a predetermined number of sub-pieces or may be constituted with a variable number of sub-pieces. The data length of each of the sub-pieces and the total number of sub-pieces that constitute each of the encrypted pieces may be specified in the content distribution system as initial values or may be specified in advance in the Torrent File. In the following section, it is assumed that the file information contained in the Torrent File includes the data length of each of the encrypted pieces, but does not necessarily have to include the hash values.

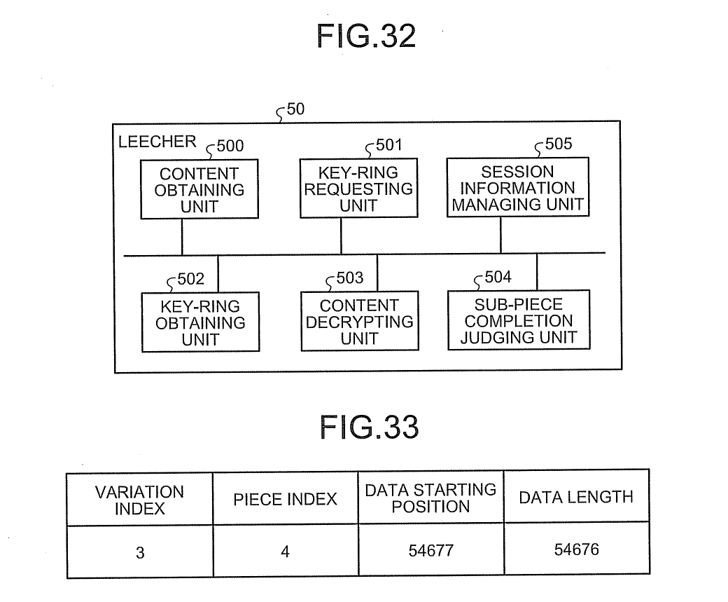

FIG. 32 is an exemplary functional diagram of the leecher 50 according to the present modification example. The leecher 50 includes a sub-piece completion judging unit 504 and a session information managing unit 505, in addition to the content obtaining unit 500, the key-ring requesting unit 501, the key-ring obtaining unit 502, and the content decrypting unit 503 described above. It is assumed that, with respect to each of the encrypted pieces, the leecher 50 is able to request the entirety of the data thereof or the sub-pieces. The former situation is similar to the first embodiment or the second embodiment described above. Thus, the latter situation will be explained below.

When transmitting a piece request to the seeder 52, the content obtaining unit 500 according to the present modification example judges whether the data of the encrypted piece that is the target to be obtained has partially been obtained already. In the case where the content obtaining unit 500 has judged that the data has partially been obtained already, the content obtaining unit 500 generates a partial data request and transmits the generated partial data request to the seeder 52. The partial data request indicates, for example, a set (i,j) made up of a specified piece index and a specified variation index that specify the encrypted piece that is the target to be obtained and that has partially been obtained as well as sub-piece specifying information that specifies a sub-piece that constitutes partial data of the encrypted piece that has partially been obtained already. The sub-piece specifying information specifies a data range of the partial data (i.e., the sub-piece) of the encrypted piece that has partially been obtained already. The data range is specified by using, for example, an offset value expressed with a number of bytes or the like that indicates the starting position of the sub-piece, an offset value expressed with a number of bytes or the like that indicates the ending position of the sub-piece, the data length of the sub-piece, or a combination of any of these. FIG. 33 is a drawing illustrating an example of a data structure of the piece request according to the present modification example. In FIG. 33, the partial data request indicates a set made up of a specified piece index and a specified variation index, as well as the starting position and the data length of the sub-piece that serve as the sub-piece specifying information. The partial data request indicates that, of the data of the encrypted piece E(K(3,4)) [C4] that corresponds to the index (3,4), the data having a data range of which the starting position is in the 54677th byte counted from the head position (i.e., the 0th byte) and that has a data length of 54676 bytes from the starting position is specified as the sub-piece that is the target to be obtained.

When transmitting a piece request to the seeder 52, in the case where the content obtaining unit 500 has judged the data of the encrypted piece that is the target to be obtained has not partially been obtained (i.e., none of the data of the encrypted piece has been obtained yet), the content obtaining unit 500 generates a piece request as described in the first and the second embodiments and transmits the generated piece request to the seeder 52.

When the content obtaining unit 500 has obtained an encrypted piece or a sub-piece, the sub-piece completion judging unit 504 performs a completion judging process of judging whether the entirety of the data of the received encrypted piece or the encrypted piece partially constituted with the received sub-piece has already been obtained. The completion judging process is performed based on, for example, the data length or a data length calculated from the head position and the ending position of the partial data within the encrypted piece. In the present example, the sub-piece completion judging unit 504 performs the completion judging process by referring to an obtained amount indicated in session information (explained later) and the data length contained in the Torrent File. In the case where the sub-piece completion judging unit 504 has judged that, with respect to the encrypted piece that is the target of the judging process, the entirety of the data has already been obtained, and if the encrypted piece is constituted with a plurality of sub-pieces, the sub-piece completion judging unit 504 performs a completing process of completing the encrypted piece by putting together all the sub-pieces that constitute the encrypted piece.

On the contrary, in the case where the sub-piece completion judging unit 504 has judged that, with respect to the encrypted piece that is the target of the judging process, the entirety of the data has not yet been obtained, the sub-piece completion judging unit 504 refers to the session information (explained later), accesses the seeder 52 that has transmitted the one or more sub-pieces that constitute the encrypted piece, and transmits a partial data request to the seeder 52 via the content obtaining unit 500 to request one of the sub-pieces that have not yet been obtained (hereinafter, an “unobtained sub-piece”) among the sub-pieces that constitute the encrypted piece. The sub-piece completion judging unit 504 attempts to obtain the unobtained sub-piece via the content obtaining unit 500 in this manner. For example, the sub-piece completion judging unit 504 repeatedly performs the process of obtaining an unobtained sub-piece from the seeder 52 until all the sub-pieces that constitute the encrypted piece have been obtained.

The session information managing unit 505 generates the session information used for requesting again one of the unobtained sub-pieces from the seeder 52 that has previously transmitted the one or more of the sub-pieces and stores the generated session information therein. The session information indicates, for example, seeder identifying information and an obtained amount. The seeder identifying information is information that identifies the seeder 52 that has previously transmitted the one or more of the sub-pieces. The seeder identifying information may be, for example, the IP address and the port number of the seeder 52, the MAC address of the seeder 52, the subscriber's ID as described above, or a combination of any of these. The obtained amount indicates the amount of data of the encrypted piece that has already been obtained. The obtained amount may be, for example, a data length calculated from the head position of the data and the ending position of the obtained partial data within the encrypted piece, a total of the data lengths of the sub-pieces that have already been obtained among the sub-pieces that constitute the encrypted piece, or the number of sub-pieces that have already been obtained.

On the other hand, the seeder 52 reads the sub-piece that has been requested in the partial data request out of an external storage device and transmits the read sub-piece to the leecher 50. In the case where the seeder 52 has received the partial data request as shown in FIG. 33, the seeder 52 transmits the data having the specified data range, out of the encrypted piece corresponding to the specified piece index and the specified variation index indicated in the partial data request.

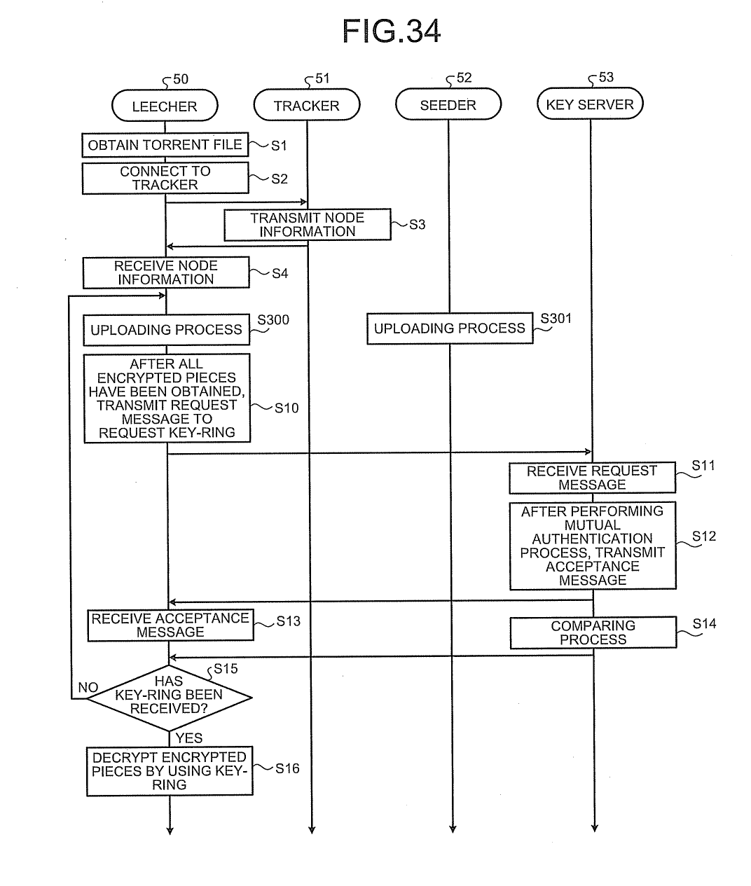

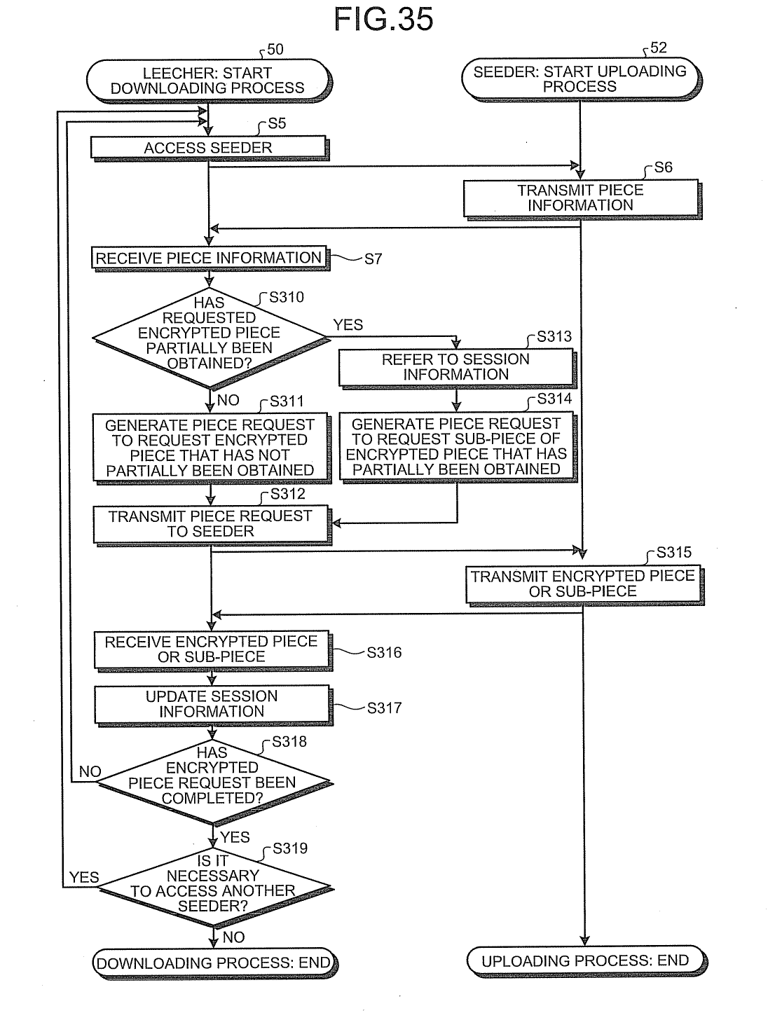

FIG. 34 is a flowchart of a procedure in a content distributing process performed in the content distribution system according to the present modification example. The processes performed at steps S1 through S4 are the same as those according to the first embodiment or the second embodiment. At step S300, the leecher 50 performs a downloading process to download the encrypted piece. On the other hand, the seeder 52 performs an uploading process to upload the encrypted piece at step S301. FIG. 35 is a flowchart of a detailed procedure in the downloading process and the uploading process. The processes performed at steps S5 through S7 are the same as those according to the first embodiment or the second embodiment. When transmitting a piece request to the seeder 52, the leecher 50 judges, at step S310, whether the data of the encrypted piece that is the target to be obtained has partially been obtained already. In the case where the leecher 50 has judged that the data has partially been obtained already (step S310: Yes), the leecher 50 refers to the seeder identifying information contained in the session information (step S313) and identifies the seeder 52 that has previously transmitted one or more of sub-pieces that constitute the encrypted piece that is the target to be obtained. The leecher 50 further generates a partial data request as shown in FIG. 33 as a piece request (step S314) and transmits the generated partial data request to the seeder 52 (step S312). On the contrary, in the case where the leecher 50 has judged that the data of the encrypted piece that is the target to be obtained has not partially been obtained (i.e., none of the data of the encrypted piece has been obtained yet) (step S310: No), the leecher 50 generates a piece request as explained in the description of the first and the second embodiments (step S311) and transmits the generated piece request to the seeder 52 (step S312).

On the other hand, when the seeder 52 has received the piece request transmitted at step S312, the seeder 52 reads the encrypted piece or the sub-piece that corresponds to the piece request out of an external storage device and transmits the encrypted piece or the sub-piece that has been read to the leecher 50 (step S315). When the leecher 50 has received the encrypted piece or the sub-piece (step S316), the leecher 50 updates the obtained amount in the session information (step S317). After that, the leecher 50 judges whether the piece request has been completed (step S318). In the present example, in the case where the leecher 50 has received a sub-piece at step S312, the leecher 50 compares the obtained amount indicated in the session information with the data length contained in the Torrent File, with respect to the encrypted piece that is partially constituted with the sub-piece. In the case where the obtained amount and the data length match, the leecher 50 judges that the entirety of the data of the encrypted piece has been obtained and judges that the piece request has been completed (step S318: Yes). After that the leecher 50 performs the completing process of completing the encrypted piece by putting together all the sub-pieces that constitute the encrypted piece. Subsequently, the leecher 50 judges whether the leecher 50 should receive another encrypted piece by accessing another seeder 52 (step S319). In the case where the result of the judging process is in the affirmative, the process returns to step S5 where the leecher 50 accesses another seeder 52. On the contrary, in the case where the result of the judging process at step S319 is in the negative, the process ends.

On the other hand, in the case where the obtained amount indicated in the session information and the data length contained in the Torrent File do not match at step S318, the leecher 50 judges that the entirety of the data of the encrypted piece has not yet been obtained and that the piece request has not been completed (step S318: No). In that situation, the process returns to step S5 where the leecher 50 refers to the session information and accesses again the seeder 52 that has previously transmitted one or more of the sub-pieces that constitute the encrypted piece. In the processes thereafter, the leecher 50 generates a partial data request for requesting one of the unobtained sub-pieces among the sub-pieces that constitute the encrypted piece and transmits the generated partial data request to the seeder 52. The leecher 50 repeatedly performs the process of obtaining an unobtained sub-piece from the seeder 52, until all the sub-pieces that constitute the encrypted piece have been obtained.

After performing the process at step S311, in the case where the leecher 50 receives an encrypted piece at step S316, there is a possibility that the leecher 50 may not be able to receive the entirety of the data of the encrypted piece for some reason. In that situation also, like the example in which the leecher 50 receives a sub-piece at step S315, the leecher 50 judges, at step S318, whether the piece request has been completed by comparing the obtained amount indicated in the session information with the data length contained in the Torrent File. In the case where the leecher 50 has judged that the piece request has not been completed, the process returns to step S5 where the leecher 50 refers to the session information and accesses again the seeder 52 that has transmitted the encrypted piece. In the processes thereafter, the leecher 50 generates a partial data request for requesting the unobtained part of the data of the encrypted piece (treated in the same manner as an unobtained sub-piece) and transmits the generated partial data request to the seeder 52. The processes performed thereafter are the same as those described above. On the other hand, in the case where the leecher 50 has judged at step S318 that the piece request has been completed in one receiving process, the leecher 50 performs the process at step S319 described above.

Returning to the description of FIG. 34, when the leecher 50 has obtained the entirety of the data for all of the encrypted pieces that respectively correspond to the pieces constituting the content and that constitute the encrypted content, the leecher 50 performs the processes at step S10 and thereafter, in the same manner as described in the first embodiment or the second embodiment.

As explained above, even in the case where the leecher 50 obtains each encrypted piece at a plurality of different times as the sub-pieces, the Torrent File is used like when the encrypted pieces are obtained. Accordingly, the key server 53 performs the comparing process on the version information contained in the Torrent File and transmits the key-ring according to the result of the comparing process. Thus, it is possible to more effectively inhibit illegitimate use of the content.

Further, yet another arrangement is acceptable in which, to specify an encrypted piece that has partially been obtained, the partial data request indicates at least a specified piece index j, instead of the set (i,j) made up of the specified piece index and the specified variation index. In that situation, yet another arrangement is acceptable in which, when the seeder 52 has received such a partial data request, the seeder 52 inquires of the leecher 50 about the specified variation index that specifies the encrypted piece that has partially been obtained and information specifying the sub-piece and obtains these types of information so that the seeder 52 is able to identify the sub-piece that is the target to be transmitted and to transmit the identified sub-piece to the leecher 50. With this arrangement, it is possible to improve the tolerance level of the seeder 52 against attacks.

It is acceptable to combine a part or all of the first and the second embodiments and any of the modification examples.

In the each embodiment described above, an arrangement is acceptable in which the programs executed by the leecher 50 are stored in a computer connected to a network such as the Internet so that the programs are provided as being downloaded via the network. Another arrangement is acceptable in which the various types of programs are provided as being recorded on a computer-readable recording medium such as a CD-ROM, a flexible disk (FD), a Compact Disk Recordable (CD-R), or a Digital Versatile Disk (DVD), in a file that is in an installable format or in an executable format. In that situation, the program is loaded into a main storage device (e.g., the RAM) when the leecher 50 reads and executes the program from the recording medium described above so that the constituent elements explained in the description of the functional configurations are generated in the main storage device. The same applies to the various types of programs implemented in the seeder 52, the various types of programs implemented in the key server 53, and the various types of programs implemented in the tracker 51.

### Other Aspects of the Invention 1

The communication apparatus according to claim 2, wherein the information obtaining unit obtains the file information and the version management information that is information showing a version updated every time the file information is updated.

### Other Aspects of the Invention 2

The communication apparatus according to claim 2, wherein the information obtaining unit obtains the file information and the version management information that is information showing a time at which the file information is generated.

### Other Aspects of the Invention 3

The communication apparatus according to claim 2, wherein the information obtaining unit obtains the file information and the version management information that is a calculated value obtained by performing a predetermined calculation process by using all or a part of the first and the second encrypted pieces indicated in the file information.

### Other Aspects of the Invention 4

The communication apparatus according to Other Aspects of the Invention 3, wherein

the information obtaining unit includes

a first obtaining unit that obtains the file information by receiving the file information from a sales server storing the most updated file information; and

a second obtaining unit that obtains the version management information that is the calculated value obtained by performing the predetermined calculation process by using all or the part of the first and the second encrypted pieces indicated in the file information.

### Other Aspects of the Invention 5

The communication apparatus according to claim 7, wherein

the information obtaining unit obtains first access information used for accessing the management server, the file information, and the version management information,

the first receiving unit accesses the management server by using the obtained first access information and receives the node information, and

the second receiving unit accesses the another communication apparatus by using the received node information, and receives, for each of the pieces, the one of the first encrypted piece and the second encrypted piece by using the file information.

### Other Aspects of the Invention 6

The communication apparatus according to claim 7, further comprising a prompt receiving unit that receives, from the management server, an obtainment prompt message that prompts obtainment of the updated file information, wherein

the information obtaining unit obtains at least the updated file information, in response to the obtainment prompt message.

### Other Aspects of the Invention 7

The key server according to claim 14, wherein the second storage unit stores at least one of validity information indicating the version management information of one or more pieces of file information having validity and validity information specifying a range of the version management information of the one or more pieces of file information having validity.

### Other Aspects of the Invention 8

The key server according to claim 13, wherein

the second storage unit stores the version management information of one or more pieces of file information and validity information indicating expiration times of the one or more pieces of file information, while keeping the version management information and the validity information in correspondence with each other, and

the judging unit judges whether the decryption keys requested in the request message are valid by judging whether the received version management information has reached the expiration time, by referring to the validity information stored in the second storage unit in correspondence with the received version management information.

### Other Aspects of the Invention 9

The key server according to claim 13, wherein

the request receiving unit receives the request message and the version management information for each of encrypted pieces each of which is the one of the first encrypted piece and the second encrypted piece corresponding to a different one of the pieces,

the judging unit judges whether the decryption keys requested in the request message are valid by comparing, for each of the encrypted pieces each of which is the one of the first encrypted piece and the second encrypted piece corresponding to a different one of the pieces, the version management information with the validity information, and

the determining unit determines whether the decryption keys should be transmitted, based on the combination of the decryption keys requested in the request message, when the judging unit has judged that all the decryption keys are valid.

### Other Aspects of the Invention 10

The key server according to claim 18, wherein

the second storage unit stores the storing proof information that is the calculated value obtained by performing the predetermined calculation process by using the selected encrypted pieces that correspond to the at least two of the pieces and each of which is the one of the first encrypted piece and the second encrypted piece, the selected encrypted pieces being selected from the encrypted pieces each of which is the one of the first encrypted piece and the second encrypted piece corresponding to a different one of the pieces, and

the storing proof judging unit judges whether the communication apparatus stores the encrypted pieces that are to be decrypted by using the decryption keys requested in the request message and each of which is the one of the first encrypted piece and the second encrypted piece corresponding to a different one of the pieces, by using the received calculated value and the stored calculated value.

### Other Aspects of the Invention 11

The key server according to claim 18, wherein

the second storage unit stores all or a part of the first and the second encrypted pieces, and

the storing proof judging unit includes

a calculating unit that calculates the calculated value by performing the predetermined calculation process by using the selected encrypted pieces that correspond to the at least two of the pieces and each of which is the one of the first encrypted piece and the second encrypted piece, the selected encrypted pieces being selected from all or the part of the first and the second encrypted pieces stored in the second storage unit, and

a judging unit that, by using the received calculated value and the stored calculated value, judges whether the communication apparatus stores the encrypted pieces that are to be decrypted by using the decryption keys requested in the request message and each of which is the one of the first encrypted piece and the second encrypted piece corresponding to a different one of the pieces.

### Other Aspects of the Invention 12

The management server according to claim 22, wherein

the information obtaining unit obtains the version management information that is information showing a version updated every time the file information is updated, and

the grouping unit organizes at least one of the communication apparatus and the another communication apparatus into a group in such a manner that communication apparatuses storing the file information of which the version management information is mutually same or of which the version management information is within a predetermined range belong to a mutually same group.

### Other Aspects of the Invention 13

The management server according to claim 22, wherein

the information obtaining unit obtains the version management information that is information showing a time at which the file information was generated, and

the grouping unit organizes at least one of the communication apparatus and the another communication apparatus into a group in such a manner that communication apparatuses storing the file information of which the version management information is mutually same or of which the version management information is within a predetermined range belong to a mutually same group.

### Other Aspects of the Invention 14

The management server according to claim 22, wherein

the information obtaining unit obtains the version management information that is a calculated value obtained by performing a predetermined calculation process by using all or a part of the first and the second encrypted pieces indicated in the file information, and

the grouping unit organizes at least one of the communication apparatus and the another communication apparatus into a group in such a manner that communication apparatuses storing the file information of which the version management information is mutually same or of which the version management information is within a predetermined range belong to a mutually same group.

### Other Aspects of the Invention 15

The management server according to claim 21, further comprising a receiving unit that receives, from an external apparatus, a halt request message for requesting that transmission of the connection destination information should be halted, when the file information has been updated, and also, the first access information that is in correspondence with the file information has been changed, wherein

when the receiving unit has received the halt request message, the information transmitting unit does not transmit the connection destination information but transmits an obtainment prompt message that prompts obtainment of the updated file information, to the communication apparatus that has accessed the management server.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus that receives a plurality of pieces that constitute a part of a content, comprising:
an information obtaining unit that obtains file information indicating all or a part of the first and the second encrypted pieces and version management information capable of judging whether the file information has validity;
a content receiving unit that receives, for each of the pieces, one of a first encrypted piece and a second encrypted piece from another communication apparatus by using the file information, a plurality of first encrypted pieces being obtained by encrypting the pieces with a first encryption key, the second encrypted piece being obtained by encrypting at least one of the pieces with a second encryption key, and the first encryption key and the second encryption key for encrypting a same piece being different from each other;
a transmitting unit that transmits, to a key server, a request message for requesting decryption keys each of which is used for decrypting the one of the first encrypted piece and the second encrypted piece received by the content receiving unit for a different one of the pieces and the version management information of the file information used to obtain the one of the first encrypted piece and the second encrypted piece in correspondence with each of the pieces; and
a key receiving unit that receives the decryption keys provided by the key server in response to the request message.

2. The apparatus according to claim 1, wherein the information obtaining unit obtains the file information and the version management information that are each updated at a predetermined time or at an arbitrary time.

3. The apparatus according to claim 1, wherein the content receiving unit includes
a third obtaining unit that obtains the version management information of the file information used to obtain the one of the first encrypted piece and the second encrypted piece stored in the another communication apparatus in correspondence with each of the pieces;
a judging unit that judges whether the one of the first encrypted piece and the second encrypted piece should be obtained in correspondence with each of the pieces from the another communication apparatus, by using the version management information obtained by the information obtaining unit and the version management information obtained by the third obtaining unit; and
a requesting unit that requests the one of the first encrypted piece and the second encrypted piece in correspondence with each of the pieces from the another communication apparatus according to a result of judgment of the judging unit.

4. The apparatus according to claim 3, wherein
the information obtaining unit obtains the file information and at least one of validity information indicating the version management information of one or more pieces of file information having validity and validity information specifying a range of the version management information of the one or more pieces of file information having validity, and
the judging unit judges whether the one of the first encrypted piece and the second encrypted piece should be obtained in correspondence with each of the pieces from the another communication apparatus, by using the version management information and the validity information obtained by the information obtaining unit and the version management information obtained by the third obtaining unit.

5. The apparatus according to claim 1, wherein the information obtaining unit obtains the file information, the version management information, and validity information indicating an expiration time of the file information, and obtains at least the updated file information based on the expiration time indicated in the validity information.

6. The apparatus according to claim 1, wherein
the communication apparatus is organized into a group in such a manner that the communication apparatus belongs to at least one group,
all or the part of the first and the second encrypted pieces indicated in the file information are different for each of the groups, and
the information obtaining unit obtains the file information corresponding to the group to which the communication apparatus belongs and the version management information capable of judging whether the file information has validity.

7. The apparatus according to claim 1, wherein the content receiving unit includes
a first receiving unit that receives, from a management server, node information used for accessing the another communication apparatus storing the one of the first encrypted piece and the second encrypted piece; and
a second receiving unit that accesses the another communication apparatus by using the received node information and receives, for each of the pieces, the one of the first encrypted piece and the second encrypted piece.

8. The apparatus according to claim 1, wherein the transmitting unit puts the version management information into the request message and transmits the request message to the key server.

9. The apparatus according to claim 1, further comprising a decrypting unit that decrypts encrypted pieces each of which is the one of the first encrypted piece and the second encrypted piece corresponding to a different one of the pieces, by using the received decryption keys.

10. A communication apparatus that receives a plurality of pieces that constitute a part of a content, comprising:
a content receiving unit that receives, for each of the pieces, one of a first encrypted piece and a second encrypted piece from another communication apparatus, a plurality of first encrypted pieces being obtained by encrypting the pieces with a first encryption key, the second encrypted piece being obtained by encrypting at least one of the pieces with a second encryption key, and the first encryption key and the second encryption key for encrypting a same piece being different from each other;
a key request transmitting unit that transmits, to a key server storing decryption keys, a request message for requesting the decryption keys each of which is used for decrypting the one of the first encrypted piece and the second encrypted piece received by the content receiving unit for a different one of the pieces;
a request receiving unit that receives, from the key server, an information request message for requesting storing proof information to prove that the communication apparatus stores the encrypted pieces that are to be decrypted by using the decryption keys requested in the request message and each of which is the one of the first encrypted piece and the second encrypted piece corresponding to a different one of the pieces;
an information transmitting unit that transmits the storing proof information to the key server in response to the information request message; and
a key receiving unit that receives all or a part of the decryption keys provided by the key server based on the storing proof information and the request message.

11. The apparatus according to claim 10, wherein
the request receiving unit receives, from the key server, a calculated value request message for requesting the storing proof information that is a calculated value obtained by performing a predetermined calculation process by using selected encrypted pieces that correspond to at least two of the pieces and each of which is the one of the first encrypted piece and the second encrypted piece, the selected encrypted pieces being selected from the encrypted pieces that are to be decrypted by using the decryption keys requested in the request message and each of which is the one of the first encrypted piece and the second encrypted piece corresponding to a different one of the pieces, and
the information transmitting unit includes
a calculating unit that, in response to the calculated value request message, calculates the calculated value by performing the predetermined calculation process by using the selected encrypted pieces that correspond to the at least two of the pieces and each of which is the one of the first encrypted piece and the second encrypted piece; and
a calculated value transmitting unit that transmits the calculated value to the key server.

12. The apparatus according to claim 10, wherein
the request receiving unit receives, from the key server, a calculated value request message for requesting the storing proof information that is all or a part of data obtained by joining together selected encrypted pieces that correspond to at least two of the pieces and each of which is the one of the first encrypted piece and the second encrypted piece, the selected encrypted pieces being selected from the encrypted pieces that are to be decrypted by using the decryption keys requested in the request message and each of which is the one of the first encrypted piece and the second encrypted piece corresponding to a different one of the pieces, and
the information transmitting unit includes
a joining unit that, in response to the calculated value request message, generates the data by joining together the selected encrypted pieces that correspond to the at least two of the pieces and each of which is the one of the first encrypted piece and the second encrypted piece; and
a data transmitting unit that transmits all or the part of the data to the key server.

13. A key server that communicates with a communication apparatus that receives a plurality of pieces that constitute a part of a content, comprising:
a request receiving unit that receives, from the communication apparatus, a request message for requesting decryption keys each of which is used for decrypting the one of a first encrypted piece and a second encrypted piece corresponding to a different one of the pieces and version management information capable of judging whether file information has validity, a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, the communication apparatus receives, for each of the pieces, one of the first encrypted piece and the second encrypted piece from another communication apparatus, and the file information having been used to obtain the one of the first encrypted piece and the second encrypted piece in correspondence with each of the pieces;
a first storage unit that stores the decryption keys;
a second storage unit that stores validity information used for identifying the version management information of one or more pieces of file information having validity;
a judging unit that judges whether the decryption keys requested in the request message are valid by using the received version management information and the validity information;
a determining unit that determines whether the decryption keys should be transmitted, based on a combination of the decryption keys requested in the request message, when the judging unit has judged that the decryption keys are valid; and
a key transmitting unit that reads the decryption keys corresponding to the combination requested in the request message from the first storage unit and transmits the read decryption keys to the communication apparatus, when the determining unit has determined that the decryption keys should be transmitted.

14. The server according to claim 13, wherein the second storage unit stores the validity information indicating the version management information that is information showing one or more versions of the one or more pieces of file information having validity.

15. The server according to claim 13, wherein the second storage unit stores the validity information indicating the version management information that is information showing a time at which each of the one or more pieces of file information having validity was generated.

16. The server according to claim 13, wherein the second storage unit stores the validity information indicating the version management information that is a calculated value obtained by performing a predetermined calculation process by using all or a part of the first and the second encrypted pieces indicated in any of the one or more pieces of file information having validity.

17. A key server that communicates with a communication apparatus that receives a plurality of pieces that constitute a part of a content, comprising:
a request receiving unit that receives, from the communication apparatus, a request message for requesting decryption keys each of which is used for decrypting the one of a first encrypted piece and a second encrypted piece corresponding to a different one of the pieces, a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, the communication apparatus receives, for each of the pieces, one of the first encrypted piece and the second encrypted piece from another communication apparatus;
a first storage unit that stores the decryption keys;
a second storage unit that stores storing judgment information used for judging whether the communication apparatus stores encrypted pieces that are to be decrypted by using the decryption keys requested in the request message and each of which is the one of the first encrypted piece and the second encrypted pieces corresponding to a different one of the pieces;
a request transmitting unit that transmits, to the communication apparatus, an information request message for requesting storing proof information to prove that the communication apparatus stores the encrypted pieces that are to be decrypted by using the decryption keys requested in the request message and each of which is the one of the first encrypted piece and the second encrypted pieces corresponding to a different one of the pieces;
an information receiving unit that receives the storing proof information from the communication apparatus;
a storing proof judging unit that judges whether the communication apparatus stores the encrypted pieces that are to be decrypted by using the decryption keys requested in the request message and each of which is the one of the first encrypted piece and the second encrypted piece corresponding to a different one of the pieces, by using the received storing proof information and the stored storing judgment information;
a determining unit that determines whether the decryption keys should be transmitted, based on a combination of the decryption keys requested in the request message, when the storing proof judging unit has judged that the communication apparatus stores the encrypted pieces; and
a key transmitting unit that reads the decryption keys corresponding to the combination requested in the request message from the first storage unit and transmits the read decryption keys to the communication apparatus, when the determining unit has determined that the decryption keys should be transmitted.

18. The server according to claim 17, wherein
the request transmitting unit includes
a selecting unit that selects selected encrypted pieces that correspond to at least two of the pieces and each of which is the one of the first encrypted piece and the second encrypted piece, the selected encrypted pieces being selected out of the encrypted pieces that are to be decrypted by using the decryption keys requested in the request message and each of which is the one of the first encrypted piece and the second encrypted piece corresponding to a different one of the pieces; and
a first transmitting unit that transmits, to the communication apparatus, an information request message for requesting the storing proof information that is a calculated value obtained by performing a predetermined calculation process by using the selected encrypted pieces that correspond to the at least two of the pieces and each of which is the one of the first encrypted piece and the second encrypted piece, and
the information receiving unit receives the storing proof information transmitted from the communication apparatus in response to the information request message and that is the calculated value obtained by performing the predetermined calculation process by using the selected encrypted pieces that correspond to the at least two of the pieces and each of which is the one of the first encrypted piece and the second encrypted piece.

19. The server according to claim 17, wherein
the second storage unit stores all or a part of the first and the second encrypted pieces,
the request transmitting transmits, to the communication apparatus, the information request message for requesting the storing proof information that is all or a part of data obtained by joining together selected encrypted pieces that correspond to at least two of the pieces and each of which is the one of the first encrypted piece and the second encrypted piece, the selected encrypted pieces being selected out of the encrypted pieces that are to be decrypted by using the decryption keys requested in the request message and each of which is the one of the first encrypted piece and the second encrypted piece corresponding to a different one of the pieces,
the information receiving unit receives the storing proof information transmitted from the communication apparatus in response to the information request message and that is all or the part of the data obtained by joining together the selected encrypted pieces that correspond to the at least two of the pieces and each of which is the one of the first encrypted piece and the second encrypted piece, and
the storing proof judging unit judges whether the communication apparatus stores the encrypted pieces that are to be decrypted by using the decryption keys requested in the request message and each of which is the one of the first encrypted piece and the second encrypted piece, by using the received data and the data obtained by joining together the selected encrypted pieces that correspond to the at least two of the pieces and each of which is the one of the first encrypted piece and the second encrypted piece, the selected encrypted pieces being selected from all or the part of the first and the second encrypted pieces stored in the second storage unit.

20. The server according to claim 17, further comprising a second storage unit that stores pieces of sequence information that respectively indicate combinations of the decryption keys that have already been transmitted in correspondence with the pieces, wherein
the determining unit determines whether the decryption keys should be transmitted by judging whether the second storage unit stores a piece of sequence information indicating the combination of the decryption keys requested in the request message, when all the decryption keys have judged to be valid.

21. A management server that communicates with a communication apparatus that receives a plurality of pieces that constitute a part of a content, comprising:
a first storage unit that stores connection destination information used for accessing the another communication apparatus, a plurality of first encrypted pieces being obtained by encrypting the plurality of pieces each with a first encryption key, one or more second encrypted pieces being obtained by encrypting one or more of the plurality of pieces each with a second encryption key, for each of the pieces, the first encryption key being different from the second encryption key, file information indicates all or a part of the first and the second encrypted pieces and is in correspondence with version management information with which it is possible to judge whether the file information has validity, the communication apparatus receives, for each of the pieces, one of the first encrypted piece and the second encrypted piece from another communication apparatus, by using the file information; and
an information transmitting unit that transmits the connection destination information used for accessing the another communication apparatus, when the communication apparatus has accessed the management server by using first access information that is in correspondence with the file information and is used for accessing the management server.

22. The server according to claim 21, further comprising an information obtaining unit that obtains the version management information of the file information stored in the communication apparatus, wherein
the information transmitting unit includes
a grouping unit that organizes at least one of the communication apparatus and the another communication apparatus into a group, by using the version management information; and
a transmitting unit that transmits the connection destination information used for accessing the another communication apparatus that belongs to a group to which the communication apparatus belongs.

23. The server according to claim 21, wherein
the information transmitting unit includes
a grouping unit that organizes communication apparatuses into one or more groups in such a manner that at least one of the communication apparatus and the another communication apparatus belongs to at least one of the groups and that all or a part of the first and the second encrypted pieces indicated in the file information are different for each of the groups; and
a transmitting unit that reads the connection destination information used for accessing the another communication apparatus that belongs to a group to which the communication apparatus belongs out of the first storage unit and transmits the read connection destination information.

24. The server according to claim 21, further comprising a receiving unit that receives, from an external apparatus, a halt request message for requesting that transmission of the connection destination information should be halted in a case where the file information has been updated, and also, the first access information that is in correspondence with the file information has been changed, wherein
the information transmitting unit does not transmit the connection destination information to the communication apparatus that has accessed the management server, when the receiving unit has received the halt request message.

25. The server according to claim 21, further comprising:
a receiving unit that receives, from an external apparatus, a halt request message for requesting that transmission of the connection destination information should be halted and list information indicating pieces of communication apparatus identification information for identifying communication apparatuses to which the connection destination information should not be transmitted, when the file information has been updated and the first access information in correspondence with the file information has been changed; and
an obtaining unit that obtains a piece of communication apparatus identification information for identifying the communication apparatus from the communication apparatus that has accessed the management server, wherein
the information transmitting unit does not transmit the connection destination information to any communication apparatus that has accessed the management server but whose piece of communication apparatus identification information is listed in the list information, when the receiving unit has received the halt request message and the list information.
